(19) United States
(12) Patent Application Publication
(10) Pub. No.: US 2001/0012065 A1
(43) Pub. Date: Aug. 9, 2001

(54) INFORMATION PROCESSING APPARATUS

(76) Inventors: SETAGAYA-KU EJIMA, TOKYO (JP); AKIHIKO HAMAMURA, CHIBA-SHI (JP); AKIRA OHMURA, KAWASAKI-SHI (JP)

Correspondence Address: OLIFF & BERRIDGE, P O BOX 19928, ALEXANDRIA, VA, 22320

(21) Appl. No.: 08/963,578

(22) Filed: Nov. 6, 1997

(30) Foreign Application Priority Data
Feb. 10, 1997 (JP) 9-026514

(51) Int. Cl. H04N 5/222; H04N 5/225

(52) U.S. Cl. 348/232; 348/333.01; 348/333.02; 348/220; 348/373

(57) ABSTRACT

An information processing apparatus (e.g., an electronic camera) prevents loss of an opportunity to take a picture. When shooting is completed and if a pen input setting switch is in an ON-state, the image which was photographed is displayed on a display (e.g., an LCD) for a predetermined period of time. If predetermined input is executed from the touch tablet, for example, during the predetermined period of time, a controller (e.g., a CPU) shifts to pen input mode and accepts input such as memo information. If the pen input mode setting switch is in an OFF-state, the controller causes the image currently being input to be displayed immediately after shooting. Thus, the loss of a picture taking opportunity is prevented. Various selectors other than a pen input setting switch can be used to control whether memo input is enabled or immediate shooting is enabled.

### RELATED PROVISIONAL APPLICATION

This nonprovisional application claims the benefit of Provisional Application No. 60/052,339, filed Jul. 11, 1997.

### INCORPORATION BY REFERENCE

The disclosure of the following priority application is herein incorporated by reference: Japanese Patent Application No. 9-026514, filed Feb. 10, 1997.

### BACKGROUND OF THE INVENTION

1. Field of Invention

The invention relates to an information processing apparatus. In particular, the invention relates to an information processing apparatus in which a photo image of an object is input through an optical system, converted to image signals, stored in a memory device, and displayed in a display device.

2. Description of Related Art

With a conventional electronic camera, an object is photographed. The image of this photographed object is displayed on a screen for a predetermined amount of time and the image may be verified.

However, in such a structure, for example, if an image which has been photographed previously is displayed during a predetermined period of time, a chance for taking a picture may be lost. This may occur when a need to shoot instantly arises due to an unexpected situation.

However, in recent years technology has progressed and there have been advancements in high density semiconductors. As a result, an electronic camera has been developed which is capable of not only shooting an object, but also simultaneously recording memo information. Such memo information may include information such as a line drawing of the image of the object, for example.

Such a newly developed electronic camera functions in such a manner that memo information is written for the image of the object being photographed. The image which is photographed is displayed on the screen only for a predetermined time and the memo is written during that time. With such an electronic camera, a need may arise to shoot while the image of the object is being displayed. However, shooting of a new picture is not possible until the display of the image has been completed. As a result, an opportunity to take a new picture is lost.

### SUMMARY OF THE INVENTION

In view of the problems described above, an object of the invention is to provide an electronic camera that allows shooting of a new picture when an unexpected situation arises.

The information processing apparatus according to the invention includes a first shooting mode for displaying the image signal of a photographed object for a predetermined amount of time on a display device. A second shooting mode is provided for displaying, on the display device, image signals that are continuously output (i.e., by a photoelectric converter (e.g., a CCD)) after a particular object has been photographed. A selector selects between the first and second shooting modes. The apparatus includes an input unit that inputs information. The input unit outputs a predetermined signal based on whether information is input. The selector selects either the first shooting mode or the second shooting mode based on the predetermined signal output by the input unit.

According to another aspect of the invention, a memo information input mode is provided for inputting memo information. A first sound recording mode allows memo information to be input from the input unit for a predetermined amount of time if sound information is recorded. A second sound recording mode allows recording of subsequent sound information upon completion of recording of an ongoing sound information recording process. A selector selects the first sound recording mode or the second sound recording mode. The selector selects either the first sound recording mode or the second sound recording mode based on the predetermined signal output by the input unit.

In accordance with an embodiment of the invention, an information processing apparatus includes a first shooting mode for displaying image signals of a photographed object. Such display is for a predetermined amount of time. During the predetermined amount of time, the user can verify a shot object and/or can input memo information. Also, a second shooting mode is provided for displaying, on the display device, image signals continuously output (by a CCD) after an image is photographed. Accordingly, the apparatus will be ready to take another photograph as soon as possible after a first photograph is taken. A selector selects between the first and second shooting modes based on input from the input unit. Accordingly, varied use of the apparatus is provided by the user selecting either a mode in which taking pictures is preferred, or a mode in which images which have been photographed are verified.

According to another aspect of the invention, a selector selects either the first sound recording mode or the second sound recording mode based on input from the input unit. Thus, varied use of the apparatus is provided by selecting either a mode in which recording (of sound) is preferred or a mode in which memo information is input after completion of sound recording.

### BRIEF DESCRIPTION OF THE DRAWINGS

These and other aspects and advantages of the invention will become apparent from the following detailed description of preferred embodiments when taken in conjunction with the accompanying drawings, in which:

FIG. 1 is a perspective view of a first embodiment of an electronic camera in accordance with the invention;

FIG. 2 is a back perspective view of the electronic camera shown in FIG. 1;

FIG. 3 is a perspective view of the electronic camera with the LCD cover closed in accordance with the invention;

FIG. 4 is a perspective view showing the interior of an electronic camera shown in FIG. 1 and FIG. 2;

FIGS. 5(a) and (b) show a positional relationship between the pen and the switch in accordance with the invention;

FIGS. 6(a)-(c) show a relationship between the position of the LCD cover, the power source switch and the LCD switch in accordance with the invention;

FIG. 7 is a block diagram of the electronic camera shown in FIG. 1 and FIG. 2;

FIG. 8 shows a thinning process of pixels during L mode in accordance with the invention;

FIG. 9 shows a thinning process of pixels during H mode in accordance with the invention;

FIG. 10 shows an example of a display screen of the electronic camera shown in FIG. 1 and FIG. 2 in accordance with the invention;

FIG. 11 shows an example of a menu screen displayed when a menu key is pressed in accordance with the invention;

FIG. 12 shows an example of a display screen when “menu” is selected in the screen of FIG. 11 in accordance with the invention;

FIG. 13 is an example of a display screen displayed when “menu” is selected in the screen of FIG. 12 in accordance with the invention;

FIG. 14 is a flow chart showing an example of a process executed when the release switch is pressed in accordance with the invention;

FIG. 15 shows an example of a display screen and a photograph of an intermediate image when the process of FIG. 14 is executed in accordance with the invention;

FIG. 16 shows another example of a display screen and a photograph of an intermediate image when the process of FIG. 14 is executed in accordance with the invention;

FIG. 17 is a flow chart showing another example of a process executed when the release switch is pressed in accordance with the invention;

FIG. 18 is a flow chart showing another example of a process executed when the release switch or the execution key is pressed in accordance with the invention;

FIG. 19 shows an arrangement of another embodiment in accordance with the invention;

FIG. 20 is a flow chart showing another example of a process executed when the release switch is pressed in accordance with the invention;

FIG. 21 is a flow chart showing another example of a process executed when the release switch is pressed in accordance with the invention;

FIG. 22 is a flow chart showing another example of a process executed when the release switch is pressed in accordance with the invention;

FIG. 23 shows an example of an arrangement of another embodiment of the invention; and

FIG. 24 is a flow chart showing another example of a process executed when the release switch is pressed in accordance with the invention.

### DETAILED DESCRIPTION OF PREFERRED EMBODIMENTS

While the invention will hereinafter be described in connection with preferred embodiments thereof, it will be understood that it is not intended to limit the invention to those embodiments. On the contrary, it is intended to cover all alternatives, modifications and equivalents that may be included within the spirit and scope of the invention as defined by the appended claims.

For a general understanding of the features of the invention, reference is made to the drawings. In the drawings, like reference numerals have been used throughout to designate like elements.

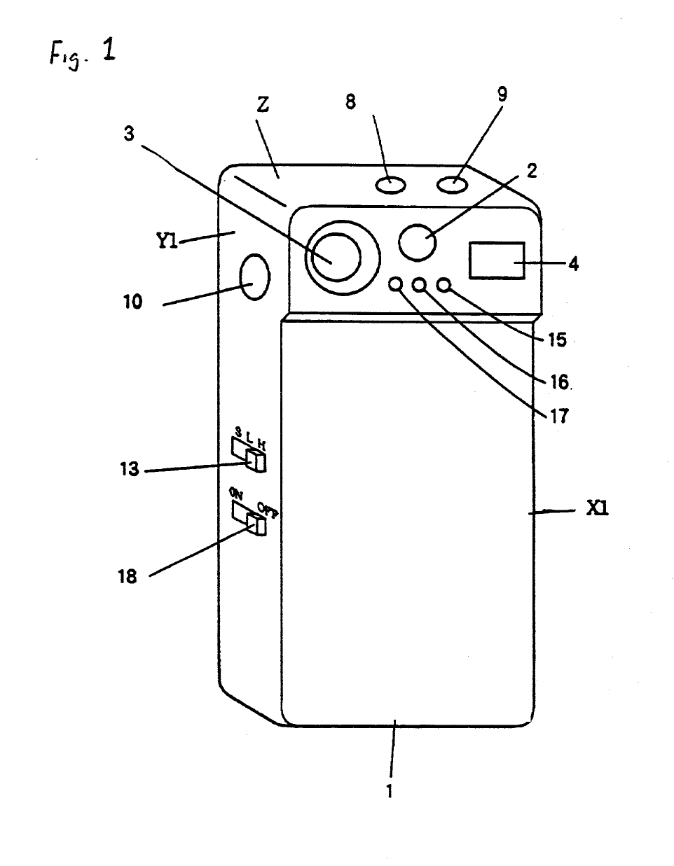

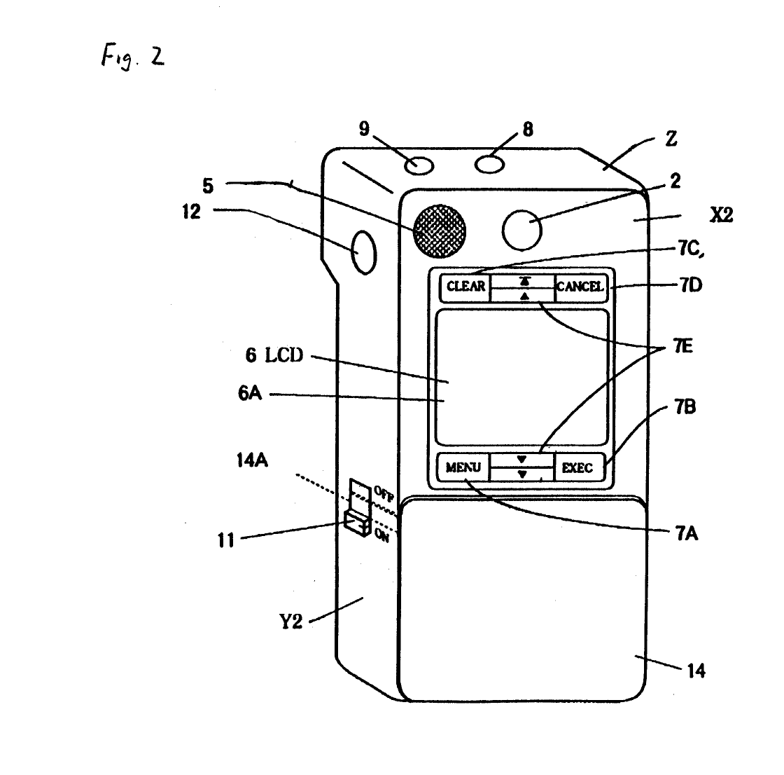

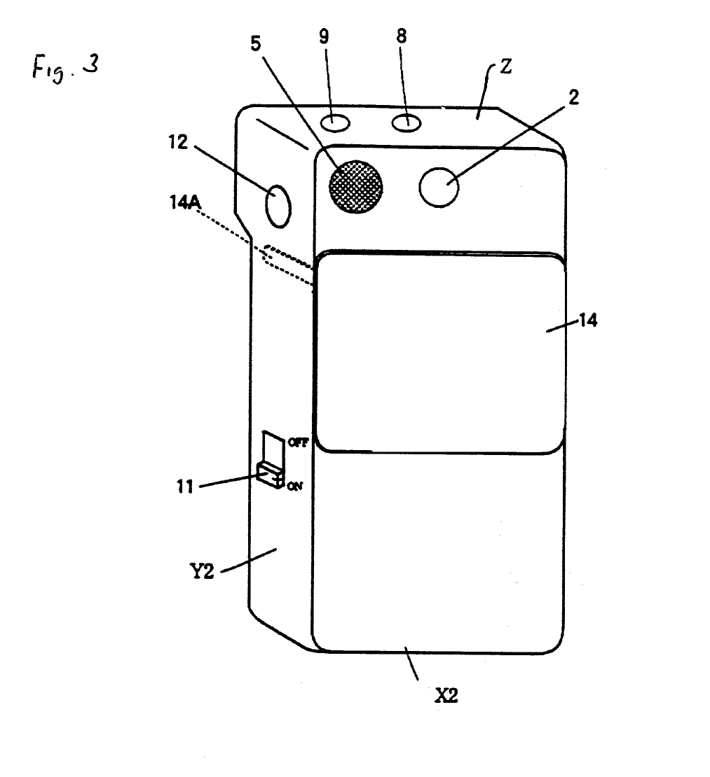

FIG. 1 and FIG. 2 are perspective views showing an embodiment of the electronic camera in accordance with the invention. With the electronic camera of the embodiment, when photographing an object, the side facing the object is designated as the X1 face, and the side facing the user is designated as the X2 face. The camera is equipped on an upper portion of the X1 side with a viewfinder 2, which is used to verify the shooting range of the object. Also on the upper portion of the X1 side are a shooting lens 3, which inputs the optical image of the object, and a light emitting unit or strobe 4, which emits light to illuminate the object being photographed.

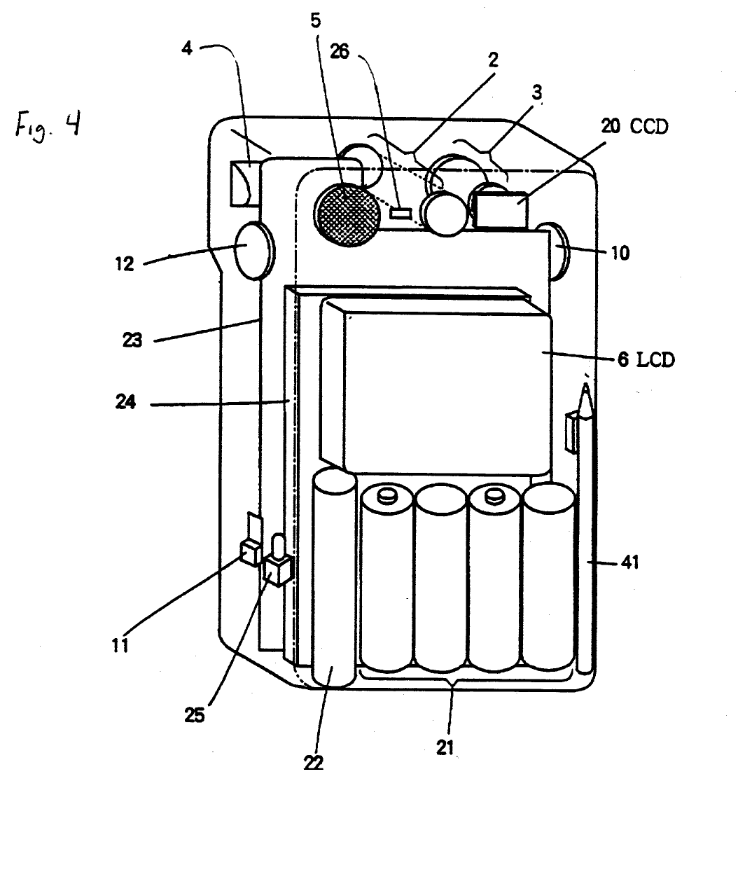

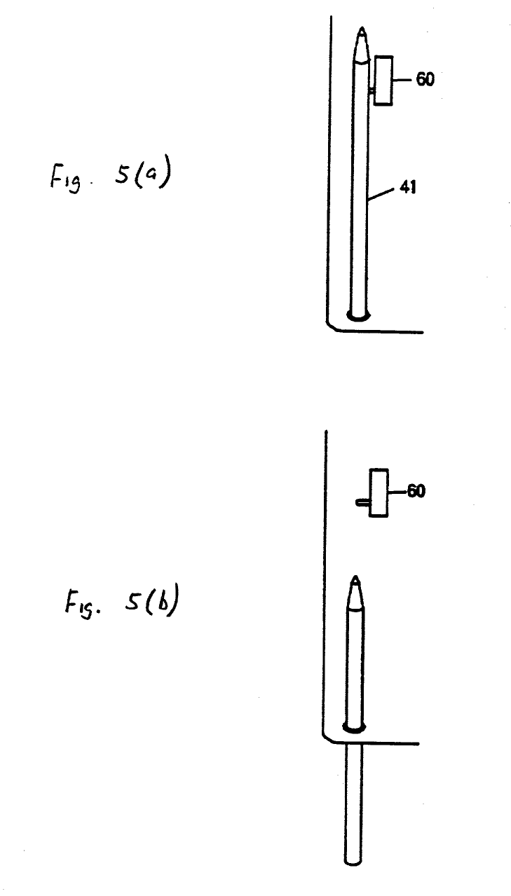

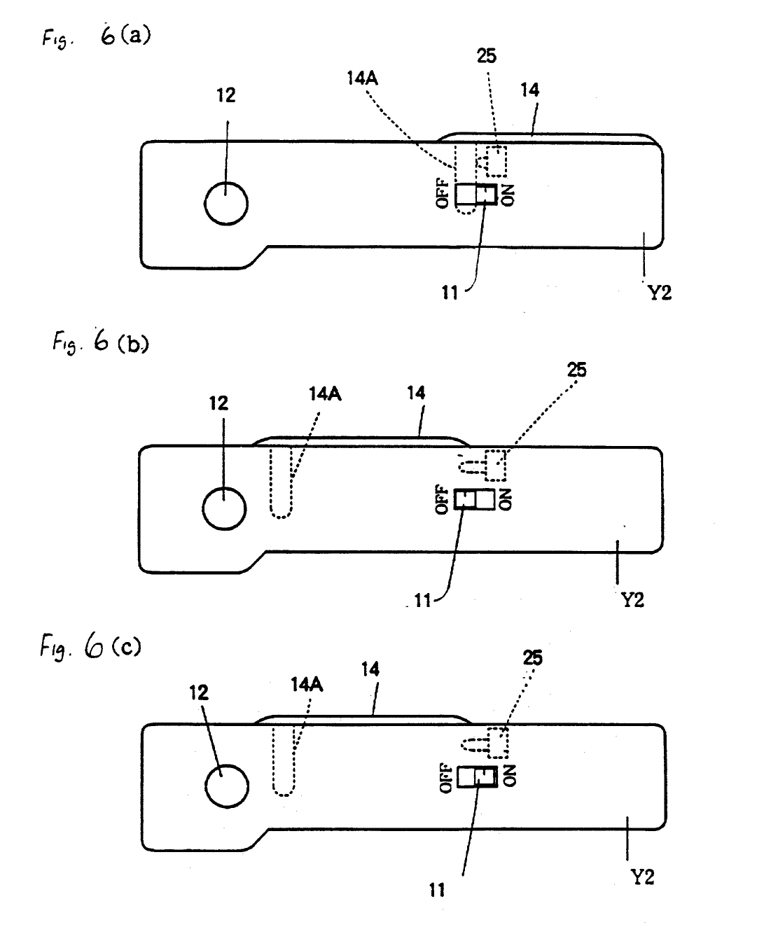

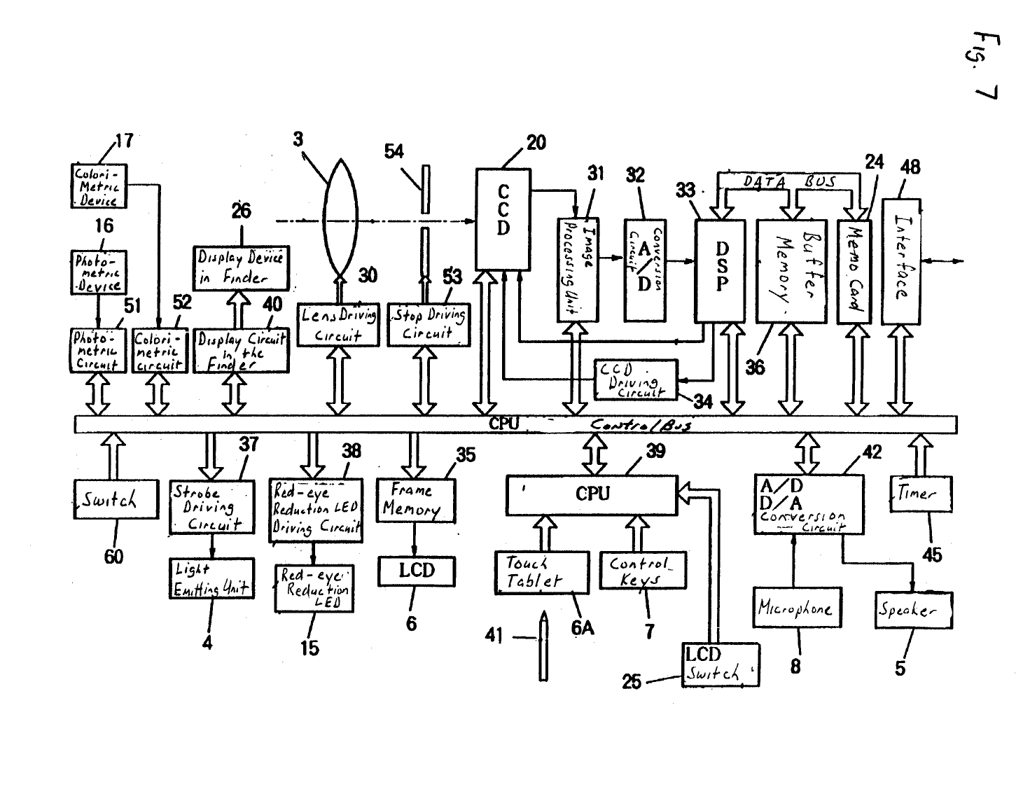

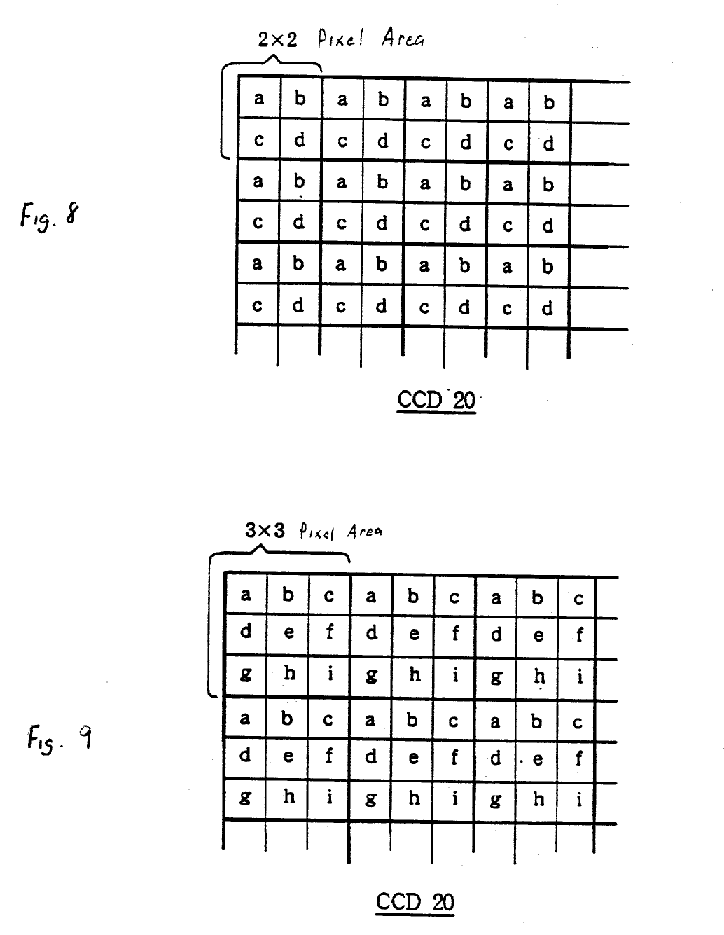

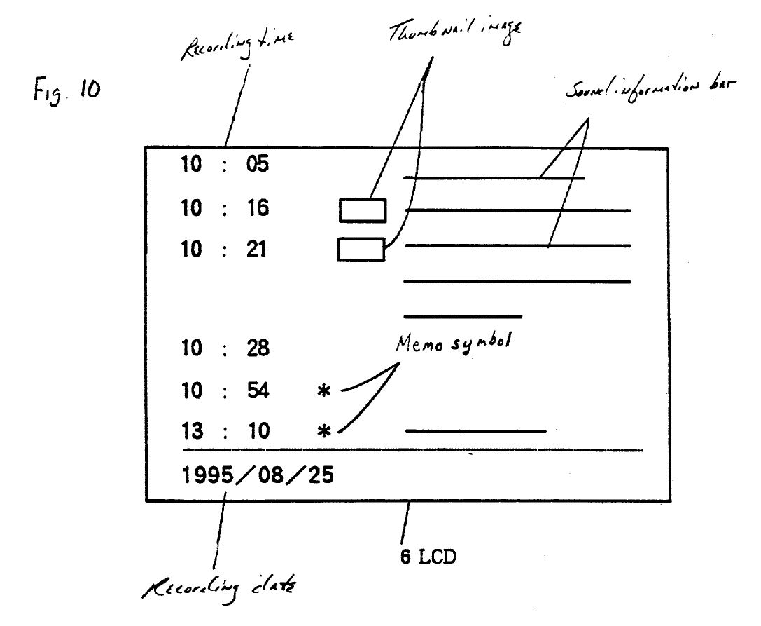

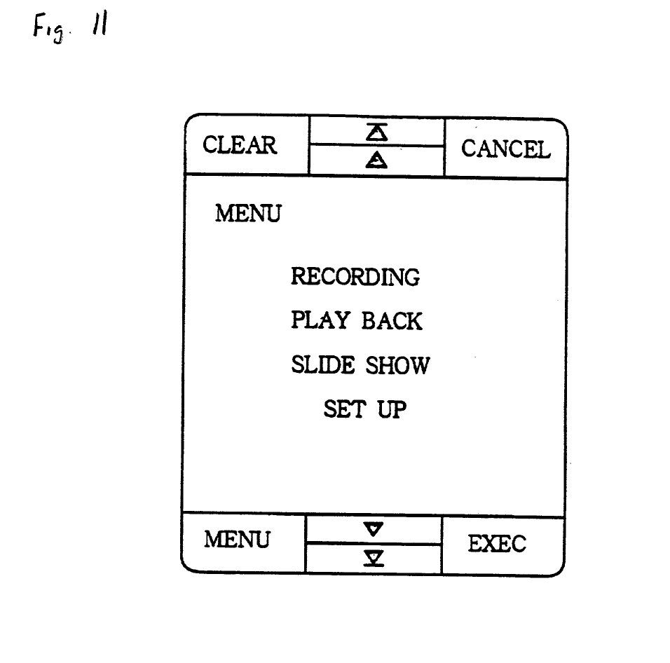

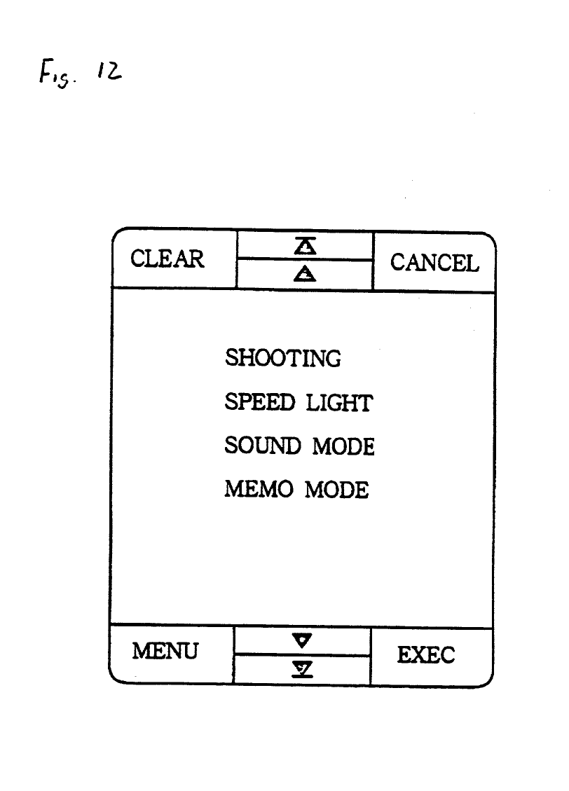

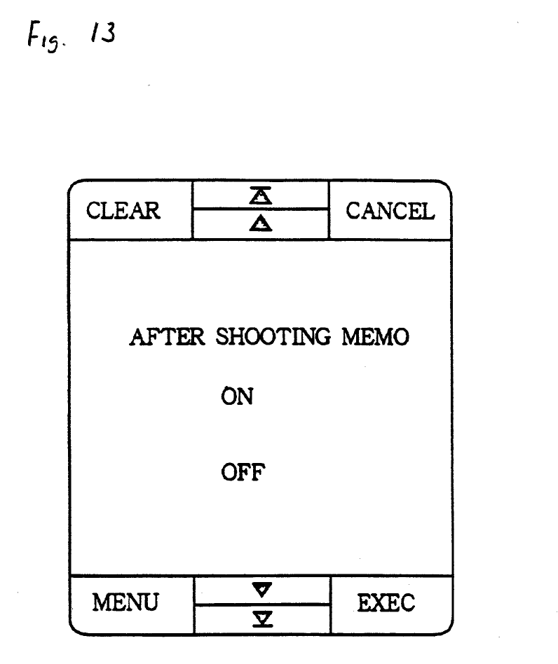

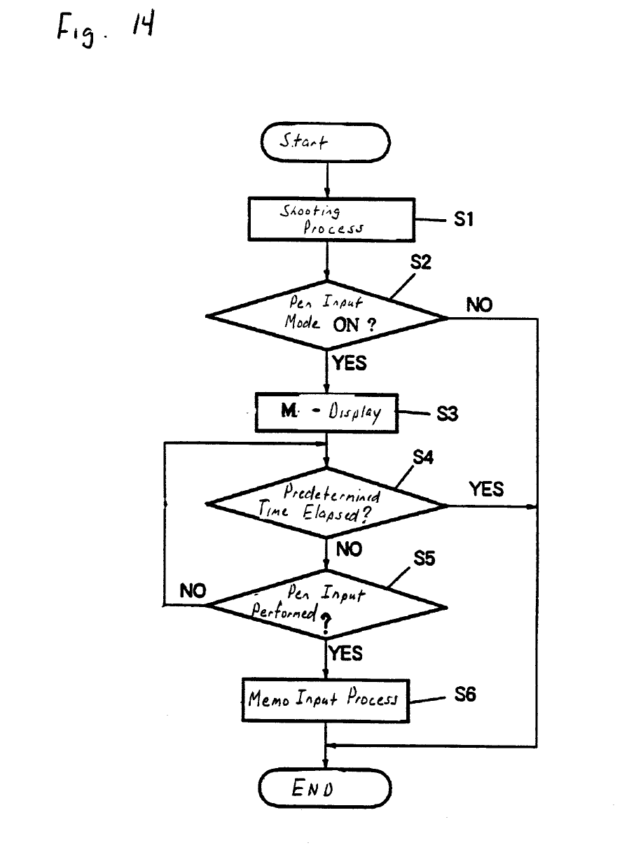

In addition, on the X1 side, a photometry device 16 is positioned which measures light during operation of the red-eye reducing LED 15. Red-eye reducing LED 15 reduces red eye by flashing before the strobe 4 flashes. Operation of the CCD 20 (shown in FIG. 4) is prevented while the strobe 4 emits light. A colorimetry device 17 measures color when operation of the CCD 20 is stopped.

Thus, on the upper portion of the X1 face are positioned the viewfinder 2, the control lens 3 and the light emitting unit 4. The upper portion of the X2 face corresponds to the upper portion of the X1 face and faces opposite the X1 face. On the X2 face are arranged viewfinder 2 and a speaker 5, which outputs sound recorded in the electronic camera 1. Also, the LCD 6 and the operation or control keys 7 are located on the X2 face and positioned vertically below the viewfinder 2, the shooting lens 3, the light emitting unit 4 and the speaker 5. On the surface of the LCD 6, a touch tablet 6A or input unit is arranged. Touch tablet 6A outputs position data corresponding to the position designated by a touching operation of a pen type pointing device, explained below. The touch tablet 6A is made of transparent material such as glass or resin. LCD 6 is formed beneath the touch tablet 6A. The user may view an image displayed on the LCD 6 through the touch tablet 6A.

Control keys 7 are operated when reproducing and displaying recording data on the LCD 6. The control keys 7 detect input by the user and output that input to the CPU 39. The menu key 7A is one of the control keys 7 and is operated when displaying the menu screen on the LCD 6. The execution key 7B is the key operated when reproducing recorded information selected by the user. The clear key 7C is operated when deleting recorded information. The cancel key 7D is operated when interrupting the reproduction process of the recorded information. The scroll key 7E is operated to scroll the screen vertically when the recorded information is displayed on the LCD 6 in a table format.

An LCD cover 14 is arranged on the X2 face and slides freely so as to protect the LCD 6 when it is not in use. When moved vertically upward, the LCD cover 14 covers the LCD 6 and the touch tablet 6A as shown in FIG. 3. When the LCD cover is moved vertically downward, the LCD 6 and the touch tablet 6A are exposed. Also, the power switch 11, discussed below, is arranged on the Y2 face and is switched to the on-position by the arm member 14A of the LCD cover 14. The top face of the electronic camera 1 is designated as the Z face. A microphone 8, for gathering sound, and an earphone jack 9, to which an earphone may be connected, are provided on the Z face.

The left face of the electronic camera 1, as shown in FIG. 1, is designated as the Y1 face. A release switch 10, which is operated to shoot an object, and a continuous shooting mode switch 13, which is operated when selecting the shooting mode are positioned on the Y1 face. Also, a pen input mode setting switch 18, which is an input unit, is positioned on the Y1 face and is used for setting the pen input mode, explained below. The release switch 10, the continuous shooting mode switch 13 and the pen input mode setting switch 18 are arranged vertically below the viewfinder 2, shooting lens 3 and the light emitting unit 4 which are provided on the upper portion of the X1 face.

The right face, as shown in FIG. 2, is designated the Y2 face. A recording switch 12, operated when recording sound, and a power source switch 11 are provided on the Y2 face. As with the release switch 10 and the continuous shooting mode switch 13 described above, the recording switch 12 and the power switch 11 are arranged vertically below the viewfinder 2, the shooting lens 3 and the light emitting unit 4, which are provided on the upper portion of the X1 face. Also, the recording switch 12 and the release switch 10, on the Y1 face, are positioned at essentially the same height relative to each other. Thus, the user does not feel a difference when the camera is held either by the right hand or the left hand.

The height of the recording switch 12 and the release switch 10 can be varied to prevent erroneous pressing of a switch arranged on an opposite side thereof. That is, erroneous pressing can result when one switch is pressed and a finger of a user presses the other side face to offset the pressing force created by the pressing of the switch.

The continuous shooting mode switch 13 is used when the user decides to shoot either one frame or multiple frames of an object by pressing the release switch 10. For example, if the indicator of the continuous shooting mode switch 13 is at the “S” position, i.e., the switch is changed to S mode, if the release switch 10 is pressed the camera shoots only one frame.

The indicator of the continuous shooting mode switch 13 may be moved to the “L” position, i.e., the switch is changed to L mode. When the release switch 10 is pressed in the L mode, the camera shoots eight frames per second as long as the release switch 10 is pressed. That is, the low speed continuous shooting mode is enabled.

Further, if the indicator of the continuous shooting mode switch 13 is at the “H” position, i.e., the switch is changed to H mode, if the release switch 10 is pressed, the camera shoots 30 frames per second as long as the release switch 10 is pressed. That is, the high speed continuous shooting mode is enabled.

Next, the internal components of the electronic camera 1 will be described. FIG. 4 is a perspective view showing an example of the internal components of the electronic camera shown in FIG. 1 and FIG. 2. The CCD 20 is positioned to the rear of the shooting lens 3 adjacent the X2 face. The optical (light) image of the object input through the shooting lens 3 is photoelectrically converted to electric (image) signals using the CCD 20.

The display device 26 is arranged inside the vision screen of the viewfinder 2. The display device 26 displays setting conditions, for example, of various functions for the user viewing a photographed object through the viewfinder 2. Four cylindrical batteries 21, for example, AA dry cell batteries, are placed side by side vertically below the LCD 6. Electric power stored in the batteries 21 is supplied to each component of the camera. A condenser 22 is positioned below the LCD 6 and adjacent the batteries 21 to accumulate an electric charge, used to cause unit 4 to flash. A space is provided to the right of the battery 21 for retaining the pen 41, i.e., a pen type pointing member.

Various control circuits are formed on the circuit board 23 to control each component of the electronic camera 1. Also, a removable memory card 24 is provided between the circuit board 23, the LCD 6 and the batteries 21. Various information input into the electronic camera 1 are recorded in a pre-assigned area of the memory card 24.

FIG. 5 shows the relationship between pen 41 and switch 60. The pen 41 may be stored in the predetermined place, a storage unit, inside the electronic camera 1. The switch 60 detects whether the pen 41 has been placed within the storage unit. If the pen 41 is placed as shown in FIG. 5(a), the switch 60 is moved to an ON state. However, if the pen 41 is placed as shown in FIG. 5(b), the switch 60 is positioned in the OFF state.

Also, as shown in FIG. 6, the LCD switch 25, which is an input unit, is arranged adjacent to the power source switch 11 and is turned on only when a plunger thereof is pressed. The LCD switch 25 is switched to the on-mode, in conjunction with the power source switch 11, by movement of the arm member 14A of the LCD cover 14 when the LCD cover 14 is moved vertically downward, as shown in FIG. 6(a).

Also, if the LCD cover 14 is moved vertically upward, the power source switch 11 may be operated by the user independently of movement of the LCD switch 25. For example, if the LCD cover 14 is closed and the electronic camera 1 is not used, the power source switch 11 and the LCD switch 25 are in the off-mode as shown in FIG. 6(b). In this mode, if the user switches the power source switch 11 to the on-mode as shown in FIG. 6(c), the power source switch 11 is in the on-mode, but the LCD switch 25 will continue to be in off-mode. Alternatively, when the power source switch 11 and the LCD switch 25 are in the off-mode, as shown in FIG. 6(b), and if the LCD cover 14 is opened, the power source switch 11 and the LCD switch 25 will both be moved to the on-mode position, as shown in FIG. 6(a). Then, when the LCD cover 14 is closed, only the LCD switch 25 will be moved to the off-mode position shown in FIG. 6(c).

In the present embodiment, the memory card 24 is removable. However, memory on which various information can be recorded may be provided on the circuit board 23. Various information recorded on the memory, for example the memory card 24, may be output to an external personal computer, for example, through an interface 48.

An example of the internal electrical components of the electronic camera 1 of the arrangement of the present embodiment is described hereinafter, with reference to the block diagram of FIG. 7. The CCD 20, which includes a plurality of pixels, photoelectrically converts an optical image formed on each pixel into an electronic image signal. The digital signal processor, hereinafter referred to as the DSP 33 supplies a CCD horizontal driving pulse to the CCD 20. The DSP 33 also controls the CCD driving circuit 34 so as to supply a CCD vertical driving pulse to the CCD 20.

The image processing unit 31 is controlled by the CPU 39 so as to sample image signals photoelectrically converted by the CCD 20 with predetermined timing. Also, the image processing unit 31 is controlled by the CPU 39 to amplify sampled signals to a predetermined level. The analog/digital conversion circuit, hereinafter the A/D conversion circuit 32, digitizes image signals which are sampled by the image processing unit 31 and supplies them to the DSP 33.

The DSP 33 controls the buffer memory 36 and the data bus connected to the memory card 24 in such a manner so as to temporarily store the image data which is supplied from the A/D conversion circuit 32 in the buffer memory 36; read the image data stored in the buffer memory 36; and record the image data in the memory card 24. Also, the DSP 33 controls the frame memory 35 so as to store image data which is supplied by the A/D conversion circuit 32. Further, the DSP 33 causes image data to display on the LCD 6, inputs the shooting image data from the memory card 24, decompresses the shooting data and stores the decompressed imaged data in the frame memory 35. The decompressed image data is displayed on the LCD 6.

Also, the DSP 33 repeatedly operates the CCD 20 by adjusting the exposure time, i.e., the exposure value, until the exposure level of the CCD 20 reaches an appropriate level. Then, the electronic camera 1 initiates further operations. Thereafter, the DSP 33 first operates the photometry circuit 51 and computes an initial value of exposure time of the CCD 20. Such exposure time corresponds to the level of light detected by the photometry device 16. As a result, adjustment of the exposure time for the CCD 20 may be accomplished in a short period of time.

Additionally, the DSP 33 executes time management for data input/output when recording on the memory card 24 and storing decompressed image data on the buffer memory 36. The buffer memory 36 is used to accommodate the difference between the data input/output speed of the memory card 24 and the CPU 39 and the DSP 33 processing speeds.

The microphone 8 inputs sound information, i.e., gathers sound, and outputs the sound information to the A/D and D/A conversion circuit 42. The A/D and D/A conversion circuit 42 converts the analog signals to digital signals and supplies the digital signals to the CPU 39. As a result, sound data supplied by the CPU 39 is changed to analog signals. The sound signal, which has been changed to analog signals, is output to the speaker 5.

The photometry device 16 measures the level of light of an object to be photographed and its surroundings. The results of the measurement is output to the photometry circuit 51. The photometry circuit 51 executes a predetermined operation on the analog signals. Specifically, the measurement results input from the photometry device 16 are converted to digital signals. The digitized signals are output to the CPU 39.

The color measuring device 17, the colorimetry device, measures the color temperature of the object and its surroundings and outputs the results of the measurement to the colorimetry circuit 52. The colorimetry circuit 52 executes a predetermined operation on the analog signals. Specifically, the color measurement results input from the photometry device 17 are converted to digital signals. The digital signals are output to the CPU 39.

The timer 45 has an internal clock circuit and outputs the data corresponding to current time to the CPU 39. The stop driving circuit 53 sets the diameter of the aperture stop 54 to a predetermined value. The stop 54 is positioned between the shooting lens 3 and the CCD 20 and changes the aperture size depending on the level of light passing into the shooting lens 3 and to the CCD 20. The switch 60, as described above, detects the position of the pen 41.

The CPU 39 stops the operation of the photometry circuit 51 and the colorimetry circuit 52 when the LCD cover 14 is open and performs operation of the photometry circuit 51 and the colorimetry circuit 52 when the LCD cover 14 is closed. The CPU 39 also stops operation of the CCD 20, i.e., the electronic shutter operation, for example, until the release switch 10 is positioned in the half-depressed mode. In this state, a first control operation is executed.

The CPU 39 receives the results of the light measurement performed by the photometry device 16, and also receives the color measurement results of the colorimetry device 17. This is accomplished by the CPU controlling the photometry circuit 51 and the colorimetry circuit 52 when operation of the CCD 20 is stopped.

Also, the CPU 39 computes a white balance adjustment value corresponding to the color temperature supplied from the colorimetry circuit 52. This computation is done using a predetermined table. The white balance value is supplied to the image processing unit 31.

More specifically, when the LCD cover 14 is closed, the LCD 6 is not used as an electronic viewfinder. As a result, operation of the CCD 20 is stopped. The CCD 20 consumes a large amount of electrical power. However, by stopping operation of the CCD 20 as described above, the power of the batteries 21 may be conserved. Also, when the LCD cover 14 is closed, the image processing unit 31 is controlled in such a manner that various processes are not executed by the image processing control unit 31 until the release switch 10 is operated, specifically, until the release switch 10 is positioned in the half-depressed mode.

When the LCD cover 14 is closed, the stop driving circuit 53 is controlled in such manner that the stop driving circuit 53 does not execute certain operations until the release switch 10 is operated, i.e., until the release switch 10 is in the half-depressed mode. Such operations may include, for example, changing of the diameter of the aperture stop 54.

Also, at the user's discretion, the CPU 39 flashes the strobe 4, by controlling the strobe driving circuit 37. Also at the user's discretion, the CPU 39 flashes the red eye reduction LED 15 prior to flashing the strobe 4 by controlling the red eye reduction LED driving circuit 38. In this situation, the CPU 39 prevents the strobe 4 from flashing when the LCD cover 14 is open, i.e., when the electronic viewfinder is used. In such manner, an object may be photographed as an image is displayed in the electronic viewfinder.

The CPU 39 records information concerning the date of shooting as image data header information. Such information is stored in the shooting image recording area of the memory card 24 and is based on date data input from the timer 45. In other words, shooting data is attached to shooting image data recorded in the shooting image recording area of the memory card 24.

Also, the CPU 39 temporarily records the digitized and compressed sound data, after compressing the digitized sound information, to the buffer memory 36. The CPU then records the sound data in the predetermined area of the memory card 24, i.e., the sound recording area. Also, date recording is simultaneously recorded in the sound recording area of the memory card 24 as sound data header information.

The CPU 39 executes an auto focus operation by controlling the lens driving circuit 30 and by moving the shooting lens 3. Also, the CPU 39, by controlling the stop driving circuit 53, changes the diameter of the aperture stop 54. Stop 54 is arranged between the shooting lens 3 and the CCD 20. Also, the CPU 39 displays settings of various operations, for example, on the display device 26 inside the viewfinder. Such display is accomplished by the CPU controlling the display circuit 40 inside the viewfinder.

The CPU 39 may exchange predetermined data with an external apparatus (not shown) using an interface (I/F) 48. Also, the CPU 39 inputs signals from the control keys 7 and processes such signals appropriately. When a predetermined position on the touch tablet 6A is pressed by the pen 41, which is operated by the user, the CPU 39 inputs X-Y coordinates of the position of the touch tablet 6A being pressed. The CPU accumulates coordinate data in the buffer memory 36. Also, the CPU 39 records the line drawing information, which is accumulated in the buffer memory 36, in the line drawing information recording area of the memory card 24. Header information, including the line drawing information input date, is also stored in the buffer memory 36 by the CPU.

The various operations of the electronic camera 1 of the present embodiment will be explained below. First, operation of the electronic viewfinder in the LCD 6 of the present apparatus will be described.

When the user half-depresses the release switch 10, the DSP 33 determines whether the LCD cover 14 is open. This determination is performed based on the value of a signal input from the CPU 39 indicative of the status of the LCD switch 25. If the LCD cover 14 is determined to be closed, operation of the electronic viewfinder is not executed. In this case, the DSP 33 stops the process until the release switch 10 is operated.

Also, if the LCD cover 14 is closed, the operation of the electronic viewfinder is not executed. As a result, the CPU 39 stops operation of the CCD 20, the image processing unit 31 and the stop driving circuit 53. Also, the CPU 39 causes the photometry circuit 51 and the colorimetry circuit 52 to operate. In addition, the CPU supplies measurement results to the image processing unit 31. The image processing unit 31 uses the values of measurement results to control the white balance and the brightness value.

If the release switch 10 is operated, the CPU 39 causes the CCD 20 and the stop driving circuit 53 to operate. Alternatively, if the LCD cover 14 is open, the CCD 20 executes the electronic shutter operation using a predetermined exposure time for each predetermined time interval and executes photoelectric conversion of the image of the object. The image is input by the shooting lens 3. The CCD then outputs the resulting image signals to the image processing unit 31.

The image processing unit 31 controls the white balance and the brightness value and executes predetermined processing on the image signals. The image processing unit 31 then outputs the image signals to the A/D conversion circuit 32. Then, if the CCD 20 is operating, the image processing unit 31 uses an adjusted value. The adjusted value is computed by the CPU 39 and is based on the output from the CCD 20. The adjusted value is used for controlling the white balance and the brightness value.

Further, the A/D conversion circuit 32 converts the image signal, an analog signal, into image data, which includes digital data. The A/D conversion circuit then outputs the image data to the DSP 33. The DSP 33 outputs the image data to the frame memory 35 and causes the LCD 6 to display an image corresponding to the image data. In this manner, in the electronic camera 1, the CCD 20 operates the electronic shutter with the predetermined time interval when the LCD cover 14 is open. Also, the CCD 20 executes operation of the electronic viewfinder by converting the signal output from the CCD 20 into image data each time. The CCD 20 then outputs the image data to the frame memory 35 and continuously displays the image of the object on the LCD 6.

If the LCD cover 14 is closed as described above, the electronic viewfinder operation is not executed. Also, operation of the CCD 20, the image processing unit 31, and the stop driving circuit 53 are stopped to conserve energy.

Next, photographing an object using the present apparatus will be described. First, the continuous shooting mode switch 13, provided in the Y1 face, may be switched to the S-mode, i.e., the mode in which only one frame is photographed. First, power is introduced to the electronic camera 1 by switching the power source switch 11, shown in FIG. 2, to the “ON” position. The process of shooting the object begins when release switch 10, provided in the Y1 face, is pressed. This is done after verifying the object with the viewfinder 2.

Then, if the LCD cover 14 is closed, the CPU 39 resumes operation of the CCD 20, the image processing unit 31 and the stop driving circuit 53 when the release switch 10 is in the half-depressed state. The process of shooting the object is started by the CPU when the release switch 10 reaches the fully-depressed state, i.e., the state in which a second control process is executed.

The image of the object being observed through the viewfinder 2 is input by the shooting lens 3 and forms an image on the CCD 20, which includes a plurality of pixels. The image formed on the CCD 20 is photoelectrically converted into an image signal by each pixel, and is sampled by the image processing unit 31. The image signal sampled by the image processing unit 31 is output to the A/D conversion circuit 32 where it is digitized. Thereafter, the signal is output to the DSP 33.

The DSP 33, after outputting the image temporarily to the buffer memory 36, reads the image data from the buffer memory 36 and compresses the image data using the JPEG (Joint Photographic Experts Group) method. This method is a combination of a discrete cosine transformation, quantization, and Huffman encoding. The DSP 33 then records the image data in the shooting image recording area of the memory card 24. Then, the shooting date data is recorded in the shooting image recording area of the memory card 24 as header information of the shooting image data.

If the continuous shooting mode switching switch 13 is switched to the S-mode, only one frame is photographed. Further shooting does not take place even if the release switch 10 is continuously pressed. Also, if the release switch 10 is continuously pressed, the image which has been photographed is displayed on the LCD when the LCD cover 14 is open.

When the continuous shooting mode switch 13 is switched to the L-mode, 8 frames per second are photographed continuously. Power is introduced into the electronic camera 1 by switching the power source switch 11 to the “ON” position. The process of shooting the object is initiated when the release switch 10, provided on the Y1 face, is pressed. If the LCD cover 14 is closed, the CPU 39 starts operation of the CCD 20, the image processing unit 31 and the stop driving circuit 53 when the release switch 10 is in the half-depressed position. The CPU begins the process of shooting the object when the release switch 10 is in the fully-depressed position.

The photographic image of an object observed through the viewfinder 2 is collected by the shooting lens 3 and forms an image on the CCD 20. The photo image formed on the CCD 20 is photoelectrically converted by each pixel into image signals, and is sampled by the image processing unit 31 at a rate of 8 times per second. Also, the image processing unit 31 ignores or thins out three-fourths of the pixels of the image (electrical) signals of all of the pixels in the CCD 20.

To explain, the image processing unit 31, as shown in FIG. 8, divides the pixels in the CCD 20 into areas composed of 2×2 pixels, i.e., 4 pixels. By this process, the image signal of one pixel, which is arranged on a predetermined location in each area, is sampled and the remaining 3 pixels are ignored. For example, at the time of the first sampling (the first frame), the pixel a at the left upper corner is sampled and other pixels b, c and d are ignored. At the time of the second sampling (the second frame), the pixel b located on the right upper corner is selected for sampling and other pixels a, c and d are ignored. Thereafter, during the third and the fourth sampling, the pixels c and d, which are respectively located at the left lower corner and the right lower corner are sampled and the rest are ignored. In other words, each pixel is selected for sampling once every four samplings.

The image signals, i.e., the image signals of one-fourth of all the pixels in the CCD 20 that are sampled by the image processing unit 31, are supplied to the A/D conversion circuit 32. At the A/D conversion circuit 32, the image signals are digitized and output to the DSP 33.

The DSP 33 outputs the image temporarily to the buffer memory 36. The DSP 33 then reads the image data from the buffer memory 36, compresses the image data using the JPEG method, and records the digitized and compressed shooting image data in the shooting image recording area of the memory card 24. At this time, the shooting date data is recorded in the shooting image recording area of the memory card 24 as header information of the shooting image data.

Explanation will hereinafter be provided with regard to the condition that the continuous shooting mode switch 13 is switched to the H-mode, a mode in which 30 frames are photographed per second. Power is introduced into the electronic camera 1 by switching the power source switch 11 to the “ON” position. The process of shooting the object begins when the release switch 10 provided on the Y1 face is pressed.

If the LCD cover 14 is closed, the CPU 39 resumes operation of the CCD 20, the image processing unit 31 and the stop driving circuit 53 when the release switch 10 is in the half-depressed position. The CPU begins the shooting process of the object when the release switch 10 is moved to the fully-depressed position.

The optical image of the object observed through the viewfinder 2 is gathered by the shooting lens 3 and imaged on the CCD 20. The optical image of the object imaged on the CCD 20 is photoelectrically converted to an image signal by each pixel and is sampled at a rate of 30 times per second by the image processing unit 31. At this time, the image processing unit 31 ignores eight-ninths of the pixels producing electrical image signals among all the pixels in the CCD 20.

In other words, the image processing unit 31 divides the pixels in the CCD 20, which are arranged in a matrix, into 3×3 pixel areas, i.e., 9 pixels, as shown in FIG. 9. The image signal of one pixel which is arranged in a predetermined position in each area is sampled at a rate of 30 times per second. The remaining 8 pixels are ignored.

For example, at the time of the first sampling (the first frame), the pixel a on the left upper corner of each area is sampled. The other pixels b through i are ignored. At the time of the second sampling (the second frame), the pixel b located on the right of a is selected for sampling and the other pixels a and c through i are ignored. Thereafter, for the third and the fourth sampling times, etc. the pixel c, the pixel d and so forth are sampled, respectively in turn, and the remaining pixels are ignored. In other words, each pixel is selected for sampling once every nine frames.

The image signals that are sampled by the image processing unit 31, i.e., the image signal of one-ninth of all the pixels in the CCD 20, are supplied to the A/D conversion circuit 32 where they are digitized and output to the DSP 33.

The DSP 33 outputs the image temporarily to the buffer memory 36. The DSP then reads the image data, compresses the image data using JPEG method, and records the digitized and compressed shooting image data in the shooting image recording area of the memory card 24.

In this situation, the object may be illuminated by operating the strobe 4 if necessary. However, when the LCD cover 14 is open, or when the LCD 6 is executing the electronic viewfinder operation, the CPU 39 prevents the strobe 4 from emitting light.

Hereinafter, the operation in which two dimensional information, i.e., pen input information, is input using touch tablet 6A will be described. When the touch tablet 6A is pressed by the tip of the pen 41, the X-Y coordinates of the point of contact are input into the CPU 39. These X-Y coordinates are stored in the buffer memory 36. The CPU 39 writes address data to the frame memory 35. The address data corresponds to each point of the X-Y coordinates. A line drawing corresponding to the X-Y coordinate contact points of the pen 41 may be displayed on the LCD 6.

As described above, since the touch tablet 6A is formed of transparent material, the user is able to view the points that are displayed on the LCD 6, i.e., the positions pressed by the tip of the pen 41. Thus, it appears that input is made by the pen directly onto the LCD 6. Thus, when the pen 41 is moved on the touch tablet 6A, a line tracing the motion of the pen 41 is displayed on the LCD 6. If the pen 41 is moved intermittently on the touch tablet 6A, a dotted line is displayed on the LCD 6 tracing the motion of the pen 41. In this manner, the user is able to input line drawing information including, for example, desired letters and drawings to the touch tablet 6A and in turn the LCD 6.

Also, the line drawing information may be input using the pen 41 when an image resulting from shooting is already displayed on the LCD 6. In such case, the line drawing information is synthesized (combined) with the shooting image information by the frame memory 35 and are displayed on the LCD 6 together.

Also, by using a predetermined pallet, the user is able to choose the color of the line drawing displayed on the LCD 6. Choices may include black, white, red, blue and others. The execution key 7B of control keys 7 may be pressed after the line drawing information is input to the touch tablet 6A by the pen 41. Then, line drawing information accumulated in the buffer memory 36 is supplied along with the header information regarding input date to the memory card 24. This information is recorded in the line drawing information area of the memory card 24. In this situation, the line drawing information which is recorded in the memory card 24 includes compressed information.

The line drawing information input using the touch tablet 6A may include information with a high spatial frequency content. As a result, if the aforementioned JPEG method is used for the compression of the line drawing image, the compression efficiency is poor. Since the amount of information does not decrease, the time required for compression and decompression becomes longer. In addition, compression using the JPEG method is lossey compression. As a result, such method is not suitable for compression of line drawing information containing a small amount of information. This is due to gathering and smearing resulting from missing information and becomes noticeable when information is decompressed and displayed on the LCD 6.

Therefore, in the present embodiment, line drawing information is compressed using the run-length method used in facsimile machines, for example. The run-length method scans the line drawing screen in the horizontal direction. The line drawing information is compressed by encoding each continuous length of the information for each color such as black, white, red and blue. Each continuous length of non-information, i.e., where there is no pen input, is also encoded.

By using the run-length method, line drawing information is compressed to a minimum amount of information. Also, control of missing information becomes possible even when the compressed line drawing information is decompressed. Also, if the amount of information is relatively small, it is possible to set the apparatus so as to not compress the line drawing information.

As described above, if the line drawing information is input by the pen when the photographed or shooting image is already displayed on the LCD 6, the pen input is synthesized with the shooting image information by the frame memory 35. The synthesized image of the shooting image and line drawing is displayed on the LCD 6. The shooting image data is recorded in the shooting image recording area of the memory card 24 and the line drawing information is recorded in the line drawing information area of the memory card 24. In this manner, two types of information are recorded in different areas. As a result, the user may erase one of the two images, for example the line drawing image, from among the shooting and line drawing synthesized image. This allows further compression of each image information using a separate compression method.

Data may be recorded in the sound recording area, the shooting image recording area, or the line drawing information recording area of the memory card 24. A table containing such data may be displayed on the LCD 6, as shown in FIG. 10. In the display screen of the LCD 6, as shown in FIG. 10, the information recording date “Aug. 25, 1995”, for example, is displayed on the bottom section of the screen. The recording time of the information that was recorded on the recording date is displayed on the left-most side of the screen.

To the right of the recording time, a thumbnail image is displayed. The thumbnail image is formed by thinning, or reducing, the bit map data for each image data of the shooting image data recorded to the memory card 24. The information shown in this display includes the shooting image information. In other words, information recorded, i.e., input, at “10:16” and “10:21” contain shooting image information. However, information recorded at “10:05”, “10:28”, “10:54” and “13:10” do not contain image information. A memo code symbol “*” indicates that a memo is recorded as line drawing information. A sound information bar is displayed to the right of the thumbnail image display area. The sound information bar has a length corresponding to the recording time length.

The user designates information to be reproduced by pressing, using the tip of the pen 41, any part of the display line of the desired information on the LCD 6 shown in FIG. 10. The selected information is reproduced by pressing the execution key 7B, using the tip of the pen 41, as shown in FIG. 2.

For example, if the line (information entry) associated with “10:05”, as shown in FIG. 10, is pressed by the pen 41, the CPU 39 reads sound data corresponding to the selected recording date and time (10:05) from the memory card 24. The CPU then decompresses the sound data and supplies the sound data to the A/D and D/A conversion circuit 42. The A/D and D/A conversion circuit 42 converts the data to analog signals, and then reproduces the sound using the speaker 5.

When reproducing shooting image data recorded in the memory card 24, the user selects the information by pressing the desired thumbnail image with the pen tip of the pen 41. The selected information can be reproduced by pressing the execution key 7B. The CPU 39 commands the DSP 33 to read the shooting image data, corresponding to the selected image shooting date, from the memory card 24. The DSP 33 then decompresses the shooting image data, i.e., compressed shooting data, read from the memory card 24. The shooting image data is then accumulated as bit map data in the frame memory 35 and displayed on the LCD 6.

The image photographed in the S-mode is displayed as a still image on the LCD 6. This still image is a reproduced image of the image signals of all the pixels of the CCD 20. The image photographed in the L-mode is displayed continuously (as a moving picture) at 8 frames per second on the LCD 6. In this case, the number of pixels displayed in each frame is one-fourth of all the pixels in the CCD 20. Human vision is sensitive to deterioration of still image resolution. As a result, the user may easily detect thinning of pixels in a still image. However, in the L-mode, the shooting speed is increased and images are reproduced at a rate of 8 frames per second. Thus, the number of pixels in each frame becomes one-fourth of the number of pixels of the CCD 20. However, the amount of information per unit time doubles compared to the still image since the human eyes receives the images at a rate of 8 frames per second.

In other words, if the number of pixels for one frame of an image which is photographed in the S-mode were one, then the number of pixels for one frame of an image photographed in the L-mode would become one-fourth. When the still image that is photographed in the S-mode is displayed on the LCD 6, the amount of information entering the human eye in 1 second is (number of pixels 1)×(number of frames 1)=1. Alternatively, when an image photographed in the L-mode is displayed on the LCD 6, the amount of information viewed by the human eye per second becomes 2=(number of pixels ¼)×(number of frames 8). In other words, twice as much information is viewed by the human eye as compared to the still image. Accordingly, even if the number of pixels in one frame is reduced to one-fourth, the user is still able to view the reproduced images without much deterioration of the image quality.

Also, in the present embodiment, a different sampling is executed for each frame and the sampled pixels are displayed on the LCD 6. As a result, an after-image effect of the human eye occurs. Thus, the user may be able to view the image photographed in the L-mode and displayed on the LCD 6 without noticing much deterioration of the image quality, even when three-fourths of the pixels are thinned out per one frame.

Also, an image photographed in the H-mode is displayed on the LCD 6 at a rate of 30 frames per second. Thus, the number of pixels displayed in each frame is one-ninth of the total number of the pixels of the CCD 20. However, for the same reason as with the L-mode described above, the user can view the image photographed in the H-mode and displayed on the LCD 6 without noticing much deterioration of image quality.

In the present embodiment, when the object is photographed in either the L-mode or the H-mode the image processing unit 31 thins out the pixels in the CCD 20 in such a manner that the user does not notice much deterioration of the image quality during reproduction. Further, the load on the DSP 33 and the decompression process unit 34 is reduced enabling low velocity and low power operation of these units. Also, the apparatus provides operation at low cost and low energy consumption.

The arrangement of the present embodiment provides for selection between two modes. In the first mode, pen input may occur immediately after shooting of an object. In such a mode, the image of the photographed object is displayed on the LCD 6 for a predetermined time period after the image is photographed. In the second mode, the image output from the CCD 20 is continuously displayed. When a photograph is taken in the second mode, the photographed image is not continuously output on the LCD 6. Rather, the CCD 20 output of the images that are received by the CCD 20 after photographing are displayed on the LCD 6. In other words, the LCD 6 is functioning as an electronic viewfinder. In any event, in the second mode, the photographed image is not displayed for a predetermined time period. Hereafter, the manner of setting these two modes and operation of each mode will be described.

FIG. 11 shows a menu screen displayed when the menu key 7A, at the bottom left of the LCD 6, is pressed. In this display example, recording, play back, slide show and set up options are displayed as selection items. On this screen, if “menu”, which is displayed at the bottom of the screen, is pressed by the pen 41, the screen shown in FIG. 12 is displayed. FIG. 12 shows a set up screen. In this display example, shooting, speed light, sound mode and memo mode options are displayed as selection items. In this screen, if “menu”, which is displayed at the bottom of the screen, is pressed the screen shown in FIG. 13 is displayed. In this display example, selection of whether memo input is performed after shooting is accomplished by selecting ON or OFF. In other words, immediately after shooting of the object, the image photographed is displayed for a predetermined amount of time. If input from the touch panel 6A is sensed, the arrangement allows selection of either a mode to perform memo input (ON is selected) or a mode to display an image from the CCD 20 immediately after shooting (OFF is selected). In this situation, the setting contents of the setting screen are stored in the predetermined area, i.e., set up recording area, of the memory card 24.

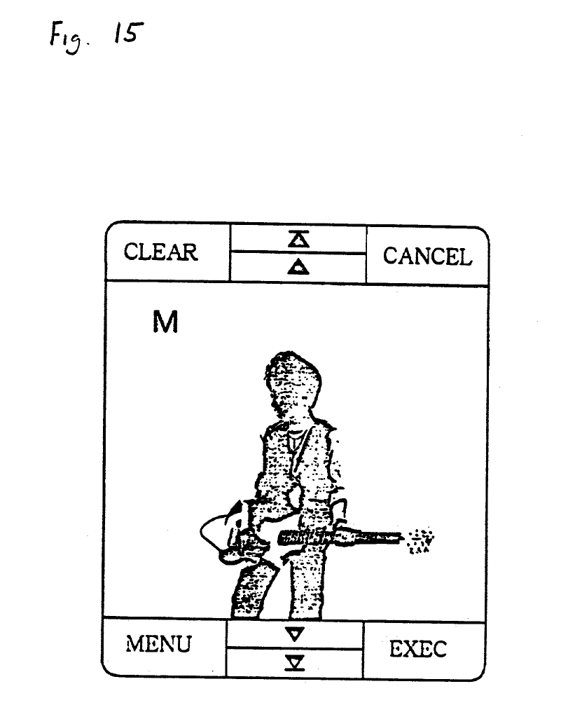

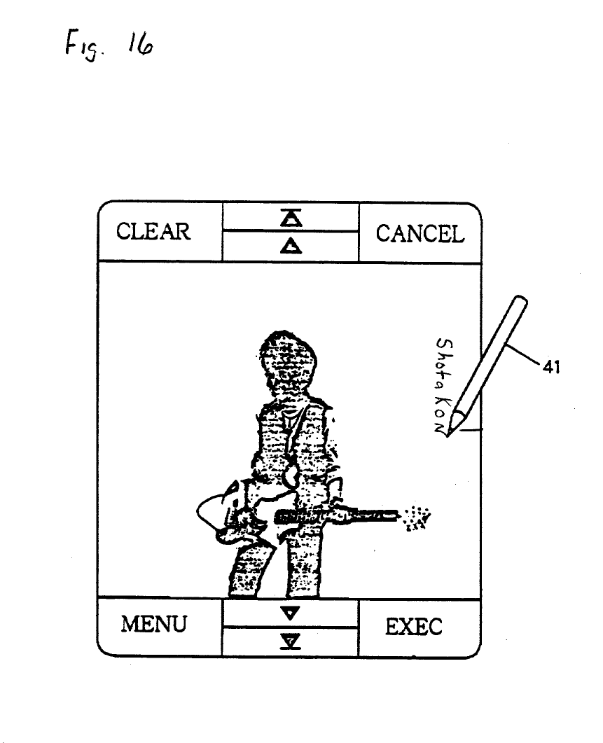

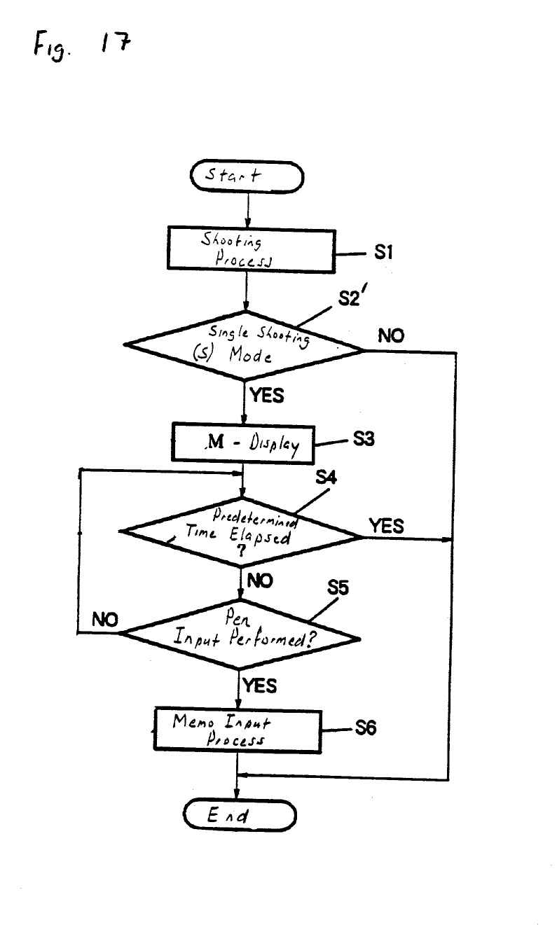

FIG. 14 is a flow chart showing an example of an operation executed when an object is photographed, i.e., the release switch 10 is pressed. Upon execution of this operation, the CPU 39 performs the shooting process at step S1. In other words, the CPU 29 supplies image signals, which have been output from the CCD 20 and which are sampled by the image processing unit 31, to the A/D conversion circuit 32. Further, the CPU digitizes the image signals and causes the DSP to perform compression using the JPEG standard. As a result, images which have been obtained are stored in the memory card 24 and are displayed on the LCD 6. Then the CPU 39 moves to step S2.

In step S2, the CPU 39 determines whether the pen input mode is in the ON-state. In other words, the CPU 39 reads information, which is displayed on the screen shown in FIG. 13, from the set up recording area in the memory card 24. As a result, if the ON-state is selected (YES), the CPU 39 moves to step S3. If the OFF-state is selected (NO), the CPU 39 ends the process (END).

When the FIG. 14 process ends, whatever image is being received by the CCD 20 is output on the LCD 6. Thus, the LCD 6 functions as an electronic viewfinder. In any event, when the FIG. 14 process ends, the photographed image is not displayed on LCD 6.

In the case that the pen input mode is in the ON-state, then the CPU 39 determines that step S2 is YES and moves to step S3. At step S3, the CPU 39 displays a character “M” on the upper left of the screen to designate that memo input is possible. Then the CPU 39 moves to step S4 and determines whether a predetermined time, 3 seconds, for example, has elapsed. As a result, if the predetermined time has elapsed (YES), the process is ended (END). If the predetermined time has not elapsed (NO), the CPU 39 moves to step S5.

FIG. 15 shows a display example of an image after shooting. As described above, the pen input mode may be positioned in ON-state. As a result, the CPU 39 moves to step S3 and “M” is displayed at the upper left of the screen. In step S4, the CPU 39 determines whether 3 seconds have elapsed. If 3 seconds have elapsed (YES), the process is ended. If 3 seconds have not elapsed (NO), the CPU 39 moves to step S5.

In step S5, the CPU 39 determines whether input using the pen 41 has been performed. If input using the pen 41 has been performed (YES), the CPU moves to step S6. If input using the pen 41 has not been executed, the CPU 39 returns to step S4 and repeats a process similar to that described above, as shown in FIG. 14.

When input using the pen 41 has been performed, the CPU determines that the decision in step S5 is YES and moves to step S6. If the decision in step S5 is NO, the CPU returns to step S4 and repeats a similar process until input using the pen 41 has been performed or the predetermined time period has elapsed. Thus, if the input is not executed, the screen shown in FIG. 13 is displayed for 3 seconds.

In step S6, the CPU 39 executes the memo input process. Specifically, the CPU 39 commands the LCD 6 to display line drawing information input from the touch tablet 6A. This is accomplished by writing the information to the frame memory 35. When the input is completed, i.e. when the execution key 7B is pressed, for example, the CPU 39 compresses the line drawing information input using the run-length method described earlier. The CPU then records the compressed information in the line drawing information recording area in the memory card 24. Then, the CPU 39 ends the process (END).

Using the above-described process, the memo input process is executed. Then, memo information, such as that shown in FIG. 16, is input. Further, when the execution key 7B is pressed, for example, the CPU 39 compresses the memo information, i.e. the line drawing, using the run-length method. The CPU then stores the compressed memo information in the line drawing information recording area in the memory card 24.

If the pen input mode is positioned in the OFF-state, the CPU determines that the step S2 result is NO and the process is ended. This enables the immediate recording of the next information.

In the arrangement of the embodiment described above, if the pen input mode is changed to the ON-state in the setting screen shown in FIG. 13, “M” is displayed only for 3 seconds on the screen after the completion of shooting. If input using the pen 41 is initiated during that time, memo information input is possible. If the pen input mode is in the OFF-state, the image from the CCD 20 is displayed continuously to immediately enable the next shooting. Thus, the setting may be readily changed depending on the objectives of the user. For example, if shooting an object is preferred, the pen input mode should be in the OFF-state. However, if the input of memo information is preferred, the pen input mode should be in the ON-state. In this situation, in the arrangement of the embodiment described above, the pen input mode is set using the setting screen shown in FIG. 13. However, setting of the mode may be executed by the pen input mode setting switch 18 shown in FIG. 1, for example. Such an arrangement enables instant switching between modes. The pen input mode also can be set by the switch 60 shown in FIGS. 5(a) and 5(b).

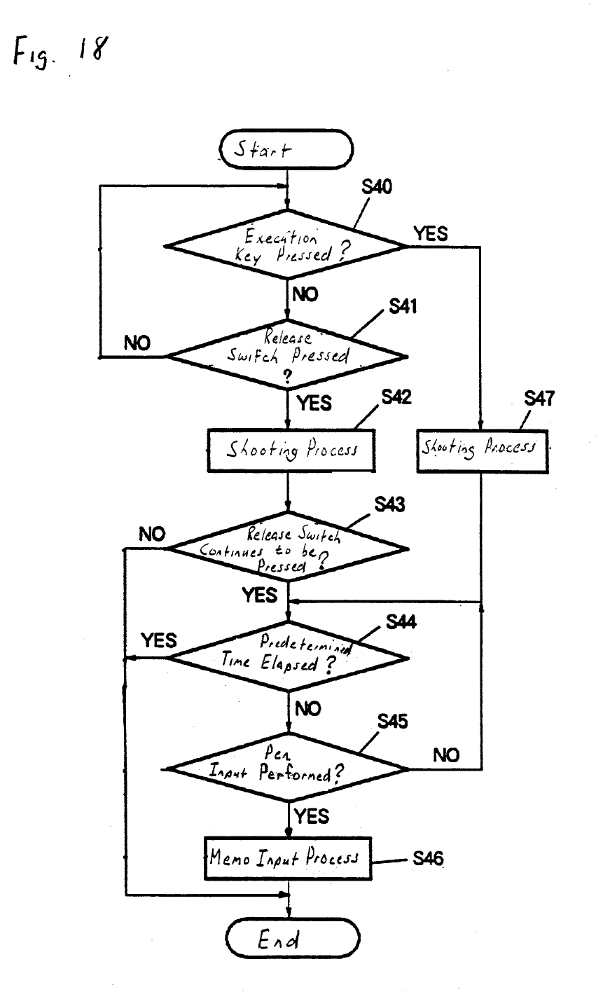

Hereinafter, another arrangement of the embodiment will be described. FIG. 17 is a flow chart showing an example of another process which is performed when an object is photographed, i.e. when the release switch 10 is pressed. In FIG. 17, steps which are the same as FIG. 14 are denoted with the same reference numerals. Accordingly, explanation of such steps is omitted. When the release switch 10 is pressed, the CPU 39 executes the shooting process in step S1 and moves to step S2′. In step S2′, the CPU 39 determines whether single shooting mode is enabled. In other words, the CPU 39 determines whether the continuous shooting mode switch 13 is set to S, i.e. single mode. As a result, if it is determined that the single shooting mode is set (YES), the CPU 39 moves to step S3. If it is determined that the single shooting mode is not set, rather setting is for continuous shooting mode, (NO), the process is ended (END).

In step S3, the CPU 39 displays an “M” on the upper left of the screen to indicate that memo input is possible. Then, the CPU 39 moves to step S4 and determines whether the predetermined time, for example 3 seconds, has elapsed. As a result, if the predetermined time is determined to have elapsed (YES), the process is ended (END). However, if the predetermined time is determined not to have elapsed (NO), the CPU 39 moves to the process of step S5.

In step S5, the CPU 39 determines whether input using the pen 41 has been performed. As a result, if input using the pen 41 has been performed (YES), the CPU moves to step S6. If input using the pen 41 is determined not to have been performed (NO), the CPU 39 returns to step S4 and repeats the process described above.

In step S6, the memo input process is executed and input of the memo information is enabled. If memo information input is finished and the execution key 7B is pressed, the input memo information is compressed by the run-length method. Further, such input memo information is stored in the memory card 24 and the process is ended (END).

In a process, such as the one described above, if the continuous shooting mode switch 13 is set at a mode other than the single shooting mode, i.e. the L-mode or the H-mode, memo information is not input. In such case, the process is ended automatically. In addition, if the continuous shooting mode switch 13 is set to the single shooting mode, the shooting image is displayed on the screen only for a predetermined time. If pen input is initiated during that time, the input of the memo information is accepted. Thus, the smooth input of memo information after shooting is accomplished. If the single shooting mode is set in the embodiment described above, transition to the pen input mode is accomplished unconditionally. However, alternatively, transition to the pen input mode may be allowed only when the single shooting mode is set and the pen input mode is in the ON-state (i.e., by menu selection or actuation of switch 18 or switch 60).

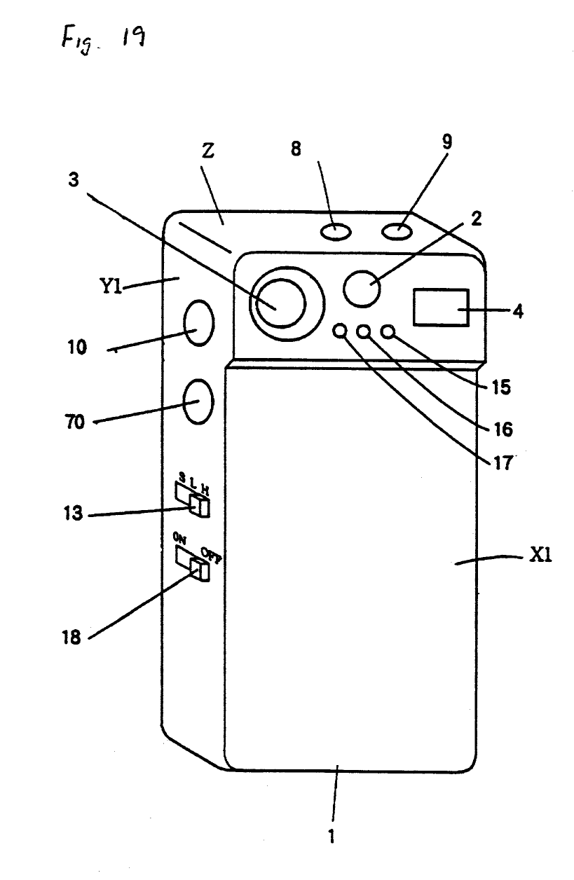

Another arrangement of an embodiment of the invention is described hereinafter, with reference to the flow chart in FIG. 18. The flow chart in FIG. 18 is an interruption process which is executed at predetermined time intervals, for example. Upon execution of this process, the CPU 39 determines in step S40 whether the execution key 7B is pressed. As a result, if the execution key 7B is determined to have been pressed (YES), the CPU 39 moves to step S47. However, if the execution key 7B is determined not to have been pressed (NO), the CPU 39 moves to step S41.

In step S41, the CPU determines whether the release switch 10 is pressed. As a result, if the release switch 10 has been pressed (YES), the CPU 39 moves to step S42. However, if the release switch 10 is determined to have not have been pressed (NO), the CPU 39 returns to step S40 and the same process as that described previously is repeated.

In step S42 and step S47, the shooting process is executed. In other words, the CPU 39 commands the DSP 33, compresses image signals which are input from the CCD 20, writes the compressed information to the shooting image recording area of the memory card, and displays the image on the LCD 6.

Upon completion of the shooting process of step S42, the CPU 39 moves to step S43 and determines whether the release switch 10 continues to be pressed. As a result, if the release switch 10 is determined not to have been continuously pressed (NO), the process is ended (END). However, if the release switch 10 is determined to have been continuously pressed (YES), the CPU 10 moves to step S44.

Alternatively, if the shooting process of step S47 is completed, the CPU 39 moves to step S44. In step S44, the CPU 39 determines whether the predetermined time, 3 seconds for example, has elapsed. As a result, if the predetermined time is determined to have elapsed (YES), the process is ended (END). However, if the predetermined time is determined not to have elapsed (NO), the CPU 39 moves to step S45.

In step S45, the CPU 39 determines whether input using the pen 41 has been performed. If input using the pen 41 is determined not to have been performed (NO), the CPU returns to step S44, and repeats the process similar to that described above. However, if input using the pen 41 is determined to have been performed (YES), the CPU 39 moves to step S46.

In step S46, the memo input process is executed. Since this memo input process is the same as the aforementioned process of FIG. 14, explanation of the same is omitted. Then, upon completion of the memo input process, the process is ended (END).

The above process is hereinafter described in further detail. In the above process, if the execution key 7B is pressed, the CPU 39 decides that the decision made in step S40 is YES. The CPU then executes the shooting process in step S47 and moves to step S44. Also, if the pen input is performed before the elapse of the predetermined time, the CPU 39 determines that the decision in step S45 is YES and memo input is executed.

Alternatively, if the release switch 10 is pressed, the CPU 39 determines that the decision in step S41 is YES. The CPU then executes the shooting process in step S42 and moves to step S43. If the release switch 10 is continued to be pressed after execution of the shooting, the CPU 39 determines that the decision in step S43 is YES and moves to step S44. Also, if the pen input is performed in such state, the CPU 39 decides that the decision at step S45 is YES and the memo input process of step S46 is executed.

In the process described above, if shooting is executed by the execution key 7B, the image which has been photographed is displayed on the LCD 6 for a predetermined amount of time and the CPU 39 waits for transition to the memo input mode (i.e., it waits for memo information to be input). Also, if the release switch 10 is pressed and shooting is executed, the CPU 39 will wait for transition to the memo input mode only if the release switch 10 is continuously pressed after shooting. On the other hand, the CPU 39 will not wait for transition to the memo input mode if the release switch 10 is pressed once and quickly released. Thus, the purpose of shooting is appropriately differentiated by the use of two keys or buttons.

In this situation, in the arrangement of the embodiment described above, if the execution key 7B is pressed, the CPU 39 waits for transition to the memo input mode. However, the CPU 39 may wait for transition to the memo input mode by the provision of a second release switch 70, which functions as an input unit, as shown in FIG. 19, for example. Specifically, the CPU waits for transition to the memo input mode when this switch is pressed or the execution key 7B is pressed.

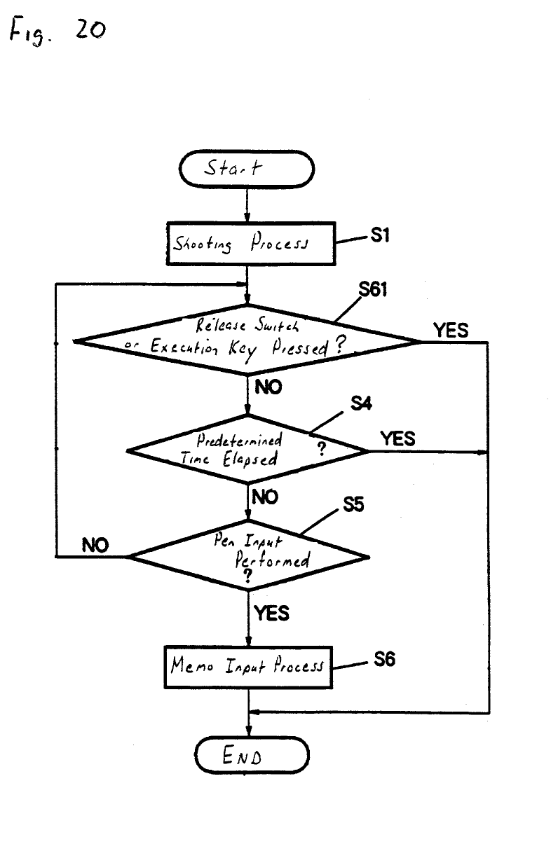

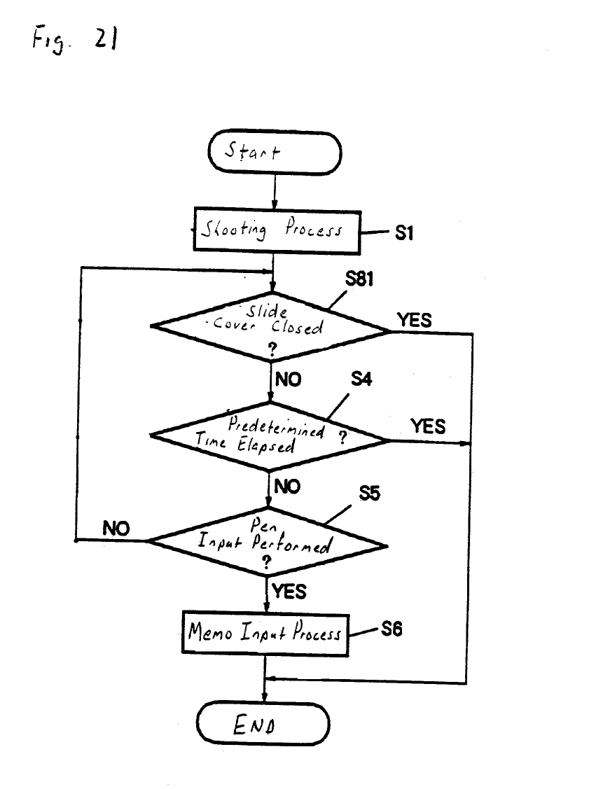

Yet another arrangement of the embodiment of the invention is described hereinafter, with reference to FIG. 20. The process shown in FIG. 20 is executed when the object is photographed, i.e. when the release switch 10 is pressed. In this process, steps which are the same as those in FIG. 14 are denoted with the same reference numerals and explanation is omitted accordingly.

Upon the execution of the process shown in FIG. 14, the initial shooting process is executed in step S1 and then the CPU 39 moves to step S61. In step S61, the CPU 39 determines whether the release switch 10 or the execution key 7B is pressed. As a result, if either the release switch 10 or the execution key 7B is determined to have been pressed (YES), the process is ended (END). If neither the release switch 10, nor the execution key 7B, is determined to have been pressed (NO), the CPU 39 then moves to step S4.

In step S4, the CPU 39 determines whether the predetermined amount of time, 3 seconds for example, has elapsed. As a result, if the predetermined time is determined to have elapsed (YES), the process is ended (END). However, if the predetermined time is determined not to have elapsed (NO), the CPU 39 moves to step S5.

In step S5, the CPU 39 determines whether input using the pen 41 has been performed. As a result, if input using the pen 41 is determined not to have been performed (NO), the CPU returns to step S61, and repeats the process similar to that of the process described above. Also, if input using the pen 41 is determined to have been executed (YES), the CPU 39 moves to step S6. In step S6, the memo input process is executed and the process is ended upon completion of the input (END).

In the process described above, if the release switch 10 or the execution key 7B are not pressed again after shooting the object, the CPU 39 is able to be placed in a state so as to wait for transition to memo input. Thus, the loss of an unexpected picture taking opportunity will be prevented.

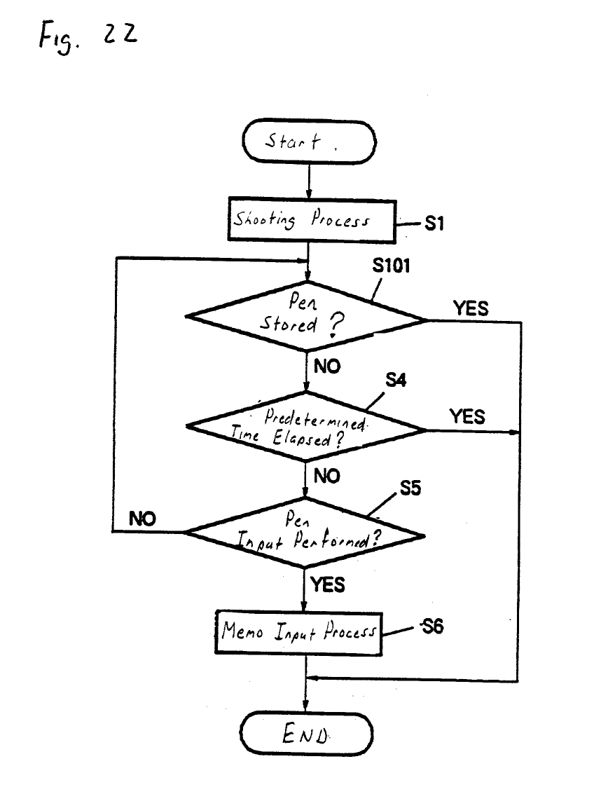

In the present arrangement of this embodiment, the LCD cover 14 is provided as shown in FIG. 2. Incidentally, if shooting is performed while the LCD cover 14 is closed, the arrangement is allowed to assume that input of memo information is not intended. In such a situation, the step in which the CPU waits for transition to memo input mode may be eliminated. FIG. 21 is a flow chart describing an example of such a process. In this figure, the same steps as those of FIG. 14 are denoted with the same indicia and the explanation of the same is omitted accordingly. The process shown in FIG. 21 is executed when the release switch 10 or the execution key 7B is pressed. Then, if the release switch 10 is pressed, for example, then the process of step S1 is executed. In step S1, the shooting process is performed, and as a result, the image which is photographed is stored in the memory card 24 and is displayed on the LCD 6. In step S81, the CPU 39 determines whether the slide cover 14 is closed. If the slide cover 14 is determined to be closed (YES), the process is ended (END). Also, if the slide cover 14 is determined to be open (NO), the CPU 39 moves to step S4.

In step S4, the CPU 39 determines whether the predetermined amount of time, for example 3 seconds, has elapsed. As a result, if the predetermined time is determined to have elapsed (YES), the process is ended (END). However, if the predetermined time is determined not to have elapsed (NO), the CPU 39 moves to step S5. In step S5, the CPU 39 determines whether input using the pen 41 has been performed. As a result, if input using the pen 41 is determined not to have been performed (NO), the CPU returns to step S81. The CPU then repeats the process similar to that of the process described above. If input using the pen 41 is determined to have been executed (YES), the CPU 39 moves to step S6.

In step S6, the memo input process is executed. Upon completion of memo input, the input memo information is stored in the memory card 24 and the process is ended (END)

In the process described above, if the slide cover 14 is closed, the CPU 39 determines that the decision in step S81 is YES and the process is ended. Thus, the shooting mode selection is enabled by the open-closed status of the slide cover 14. In other words, if picture taking is preferred, the slide cover should be closed.

Next, FIG. 22 is a flow chart showing an example of a process which selects the shooting mode by determining whether the pen 41 is stored in the main body of the electronic camera 1. The process shown in FIG. 22 is executed when the release switch 10 or the execution key 7B is pressed. If the release switch 10 is pressed, for example, then the process of step S1 is executed. In step S1, the shooting process is executed and as a result, the image which is photographed is stored in the memory card 24 and displayed on the LCD 6.

In step S101, the CPU 39 compares the output from the switch 60, as illustrated in FIG. 5, and determines whether the pen 41 is stored. As a result, if the pen 41 is determined to have been stored (YES), the process is ended (END). However, if the pen 41 is determined not to have been stored (NO), the CPU 39 moves to step S4. In step S4, the CPU 39 determines whether the predetermined amount of time, for example 3 seconds, is elapsed. If the predetermined time is determined to have elapsed (YES), the process is ended (END). However, if the predetermined time is determined not to have elapsed (NO), the CPU 39 moves to step S5.

In step S5, the CPU 39 determines whether input using the pen 41 has been performed. As a result, if input using the pen 41 is determined not to have been performed (NO), the CPU returns to step S101, and the process is repeated similar to that described above. However, if input using the pen 41 is determined to have been executed (YES), the CPU 39 moves to step S6. In step S6, the memo input process is executed. Upon completion of memo input, the memo information being input is stored in the memory card 24 and the process is ended (END).

With the process described above, if the pen 41 is stored in the electronic camera 1, the CPU 39 will thus determine that the decision at step S101 is YES and the process is ended. Thus, if the pen 41 is stored, the CPU 39 assumes that input of memo information is not intended and the preferred mode for taking pictures is automatically executed.

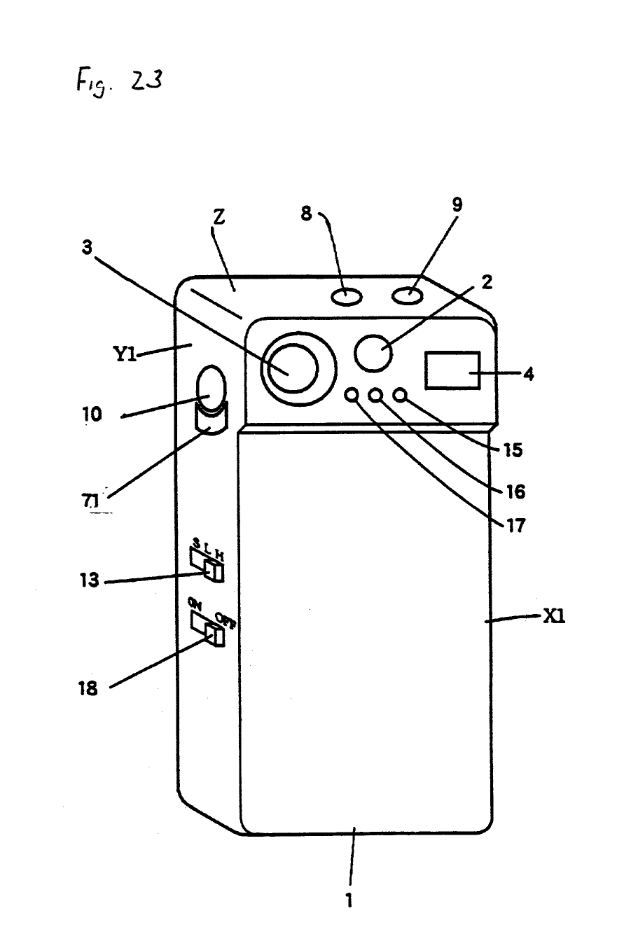

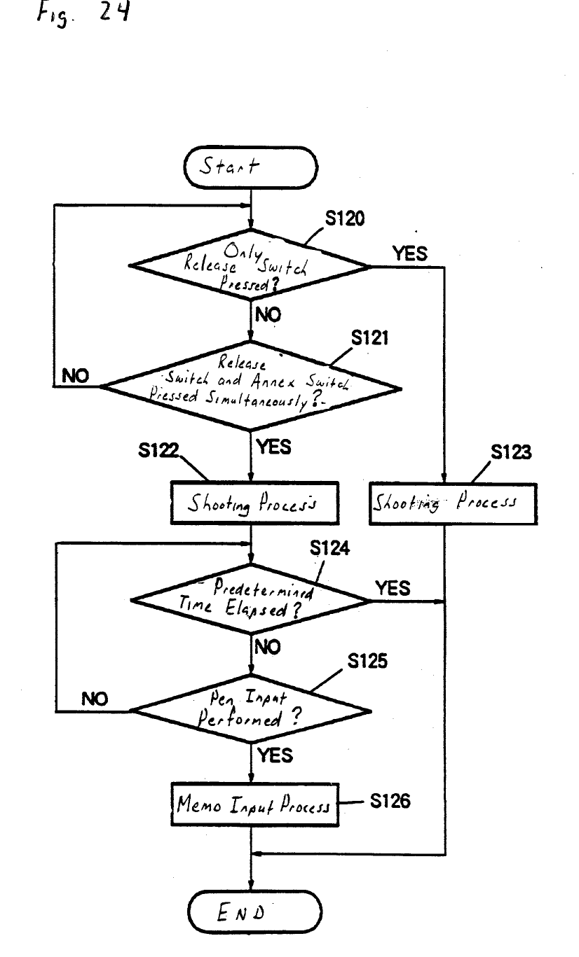

FIG. 23 shows an electronic camera according to another example of an embodiment of the invention. In this example, an annex switch 71, which functions as an input unit, is added to the arrangement shown in FIG. 1. The annex switch 71 may be pressed simultaneously with the release button 10. The remainder of the camera is the same as shown in FIG. 1.

FIG. 24 is a flow chart showing an example of a process which is executed in accordance with the embodiment shown in FIG. 23. This process is executed at predetermined time intervals. Upon execution of this process, the CPU determines at step S120 whether only the release switch 10 is pressed. As a result, if only the release switch 10 is determined to have been pressed (YES), the CPU 39 moves to step S123. If the release switch 10 is determined not to be the only switch pressed (NO), the CPU 39 moves to step S121.

In step S121, the CPU determines whether both the release switch 10 and the annex switch 71 are pressed simultaneously. As a result, if both the release switch 10 and the annex switch 71 are determined to not have been pressed simultaneously (NO), the CPU 39 returns to step S120, and the same process as that described before is repeated. However, if both the release switch 10 and the annex switch are determined to be pressed simultaneously (YES), the CPU 39 moves to step S122.

In step S122 and S123, the shooting process is executed and the image which is photographed is displayed on the LCD 6 and is stored in the memory card 24. Upon completion of step S123, the process is ended (END) Upon completion of step S122, the CPU 39 moves to step S124 and determines whether the predetermined amount of time, for example 3 seconds, has elapsed. As a result, if the predetermined time is determined to have elapsed (YES), the process is ended (END). However, if the predetermined time is determined not to have elapsed (NO), the CPU 39 moves to step S125.

In step S125, the CPU 39 determines whether input using the pen 41 has been performed. As a result, if input using the pen 41 is determined not to have been performed (NO), the CPU returns to step S124, and repeats a process similar to that of the process described above. However, if input using the pen 41 is determined to have been initiated (YES), the CPU 39 moves to step S126. In step S126, the memo input process is executed. Then, when the input of memo information is completed, the memo information being input is stored in the memory card 24 and the process is ended (END).

In the process described above, if only the release button 10 is pressed, only shooting is performed. However, if the annex switch 71 is pressed simultaneously with the release button 10, the CPU 39 waits for transition to the pen input mode. Thus, by pressing the annex switch 71 during shooting, appropriate selection of the memo input mode is enabled.

In the arrangement of the embodiment above, a mode to execute memo input and a mode not to execute memo input after shooting are provided. A user enables these two modes by switching between them as needed. However, a mode in which the photographed image may be displayed for a predetermined period of time and a mode in which the image from the CCD 20 is continuously displayed after shooting may also be provided independent of memo input. A user may enable these two modes by switching between them as needed. In such an arrangement, if taking pictures is preferred, the mode in which the photographed image is not displayed should be selected. If the user wants to verify the images being photographed, one after another, the mode in which the image being photographed is displayed for a predetermined period of time should be selected.

Additionally, in the arrangement of the embodiment above, an illustration is provided using an example in which an image of an object is photographed. However, the invention is not limited to images, but may also be applied to sound and similar input, for example. In other words, a mode to input memo or a mode not to input memo, after recording sound (instead of a photo image), may be provided and selected if needed. Such an apparatus is operable in a first sound recording mode and in a second sound recording mode. When in the first sound recording mode, the selection of a memo information input mode is allowed for a predetermined period of time when sound information is recorded. The memo information input mode allows for the input of memo information as a line drawing. When in the second sound recording mode, the recording of subsequent sound information is allowed as soon as an ongoing sound information recording process is completed.

The three second predetermined time period was merely an example. The time period can be shorter or longer than 3 seconds.

Although the JPEG and run-length encoding compression techniques were described, other compression techniques (or no compression at all) can be used with the invention.

Additionally, although a CCD 20 was used to photoelectrically convert a light image to image signals, other photoelectric converters can be used. For example, a CMOS device or a PSD (Photo Sensitive Diode) can be used as a photoelectric converter.

The invention is not limited to implementation by a programmed general purpose computer as shown in the preferred embodiment. For example, the invention can be implemented using one or more special purpose integrated circuit(s) (e.g., ASIC). It will be appreciated by those skilled in the art that the invention can also be implemented using one or more dedicated or programmable integrated or other electronic circuits or devices (e.g., hardwired electronic or logic circuits such as discrete element circuits, or programmable logic devices such as PLDs, PLAs, PALs or the like). In general, any device or assembly of devices on which a finite state machine capable of implementing the flowcharts shown in FIGS. 14, 17, 18, 20-22 and 24 can be used.

While the invention has been described in conjunction with specific embodiments thereof, it is evident that many alternatives, modifications and variations may be apparent to those skilled in the art. Accordingly, the preferred embodiments of the invention as set forth herein are intended to be illustrative, not limiting. Various changes may be made without departing from the spirit and scope of the invention as defined in the following claims.

What is claimed is:

1. An information processing apparatus that inputs a photo image of an object through an optical system, converts the photo image to image signals, stores the image signals in a memory, and displays image signals in a display device, said information processing apparatus comprising:
means for selectively operating said apparatus in a first shooting mode and in a second shooting mode, when in said first shooting mode said means displaying image signals of a photographed object for a predetermined period of time on said display device after the photographed object is photographed, and when in said second shooting mode said means displaying on said display device image signals that are continuously output after shooting said photographed object;
selection means for selecting between said first shooting mode and said second shooting mode;
input means for inputting information, said input means outputting a predetermined signal based on whether said information is input; and
said selection means selecting either said first shooting mode or said second shooting mode based on the predetermined signal output from said input means.

2. The information processing apparatus according to claim 1, wherein said apparatus is operable in a memo information input mode for recording memo information which is input as a line drawing, and wherein
said selection means enables said memo information input mode if said first shooting mode is selected and the predetermined signal is output by said input means during said predetermined period of time.

3. The information processing apparatus according to claim 1, further comprising a cover that is movable between an open position for viewing the display device and a closed position for protecting said display device, wherein when said cover is in said closed position, said selection means selects said second shooting mode and stops the operation of said display device.

4. The information processing apparatus according to claim 1, wherein said input means includes a touch tablet, said apparatus further comprising storage means for storing a pointing device for pointing to positions on said touch tablet, and wherein said selection means selects said second shooting mode when said pointing device is stored in said storage means.

5. The information processing apparatus according to claim 1, wherein said apparatus is operable in a single shooting mode for shooting a single said photo image and a continuous shooting mode for consecutively shooting a plurality of said photo images, wherein
said selection means selects said first shooting mode when said apparatus is operating in said single shooting mode, and selects said second shooting mode when said apparatus is operating in said continuous shooting mode.

6. The information processing apparatus according to claim 1, wherein when predetermined input is made from said input means when said image signal is displayed on said display device in said first shooting mode, said selection means switches from said first shooting mode to said second shooting mode.

7. An information processing apparatus that records and reproduces sound information and memo information that is input as a line drawing, comprising:
input means for inputting information and for outputting a predetermined signal;
means for operating said apparatus in a memo information input mode for inputting said memo information;
means for operating said apparatus in a first sound recording mode that allows selection of said memo information input mode to be input from said input means for a predetermined period of time when said sound information is recorded;
means for operating said apparatus in a second sound recording mode for allowing the recording of subsequent sound information as soon as an ongoing sound information recording process is completed;
selection means for selecting between said first sound recording mode and said second sound recording mode, said selection means selecting either said first sound recording mode or said second sound recording mode based on said predetermined signal output from said input means.

8. An information processing apparatus comprising:
a photoelectric converter that converts an optical image of an object into an image signal;
a display that displays the image signal converted by said photoelectric converter;
a cover that is movable between an open position for viewing the display and a closed position for covering said display;
a detector that detects whether said cover is in the closed position;
an input device that inputs line drawing information; and
a controller that prevents an input by said input apparatus when said detector detects that said cover is in the closed position.

9. The information processing apparatus according to claim 8, wherein said input apparatus includes a touch tablet that overlaps said display.

10. An information processing apparatus comprising:
a photoelectric converter that converts an optical image of an object into an image signal;
a display that displays the image signal converted by said photoelectric converter;
an input device including a touch tablet that inputs line drawing information;
an indicator that indicates a specified position of said touch tablet;
a holder that holds said indicator;
a detector that detects whether said indicator is held in said holder; and
a controller that prevents an input by said input device when said detector detects that said indicator is held in said holder.

11. An information processing apparatus comprising:
a photoelectric converter that converts an optical image of an object into an image signal;
a display that displays the image signal converted by said photoelectric converter;
a selector that selects between a single shooting mode that photographs a single frame, and a continuous shooting mode that consecutively photographs several frames;
an input device that inputs line drawing information; and
a controller that prevents an input by said input device when said selector selects the continuous shooting mode.

12. An information processing apparatus comprising:
a photoelectric converter that converts an optical image of an object to image signals;
a display device that displays the image signals;
an input device that inputs information, said input device outputting a predetermined signal based on whether said information is input; and
a controller coupled to said photoelectric converter, said display and said input device to selectively operate said apparatus in a first shooting mode and in a second shooting mode, when in said first shooting mode said controller displaying image signals of a photographed object for a predetermined period of time on said display after said photographed object is photographed, and when in said second shooting mode said controller displaying on said display image signals that are continuously output by said photoelectric converter after shooting said photographed object;
said controller selecting between said first shooting mode and said second shooting mode based on said predetermined signal output from said input device.

13. The information processing apparatus according to claim 12, wherein said apparatus is operable in a memo information input mode to record memo information input as a line drawing, and wherein:
said controller enables said memo information input mode if said first shooting mode is selected and the predetermined signal is output by said input device during said predetermined period of time.

14. The information processing apparatus according to claim 12, further comprising:
a cover that is movable between an open position for viewing the display and a closed position for protecting said display, wherein:
when said cover is in said closed position, said controller selects said second shooting mode and stops the operation of said display.

15. The information processing apparatus according to claim 12, wherein said input device includes a touch tablet, said apparatus further comprising:
a holder that holds a pointing device that is used to point to positions on said touch tablet, and wherein:
said controller selects said second shooting mode when said pointing device is stored in said holder.

16. The information processing apparatus according to claim 12, wherein said apparatus is operable in a single shooting mode for shooting a single photographic image and a continuous shooting mode for consecutively shooting a plurality of said photographic images, wherein:
said controller selects said first shooting mode when said apparatus is operating in said single shooting mode, and selects said second shooting mode when said apparatus is operating in said continuous shooting mode.

17. The information processing apparatus according to claim 12, wherein when predetermined input is made from said input device when said image signal is displayed on said display in said first shooting mode, said controller switches from said first shooting mode to said second shooting mode.

18. The information processing apparatus according to claim 12, wherein said input device includes a touch tablet.

19. The information processing apparatus according to claim 12, wherein said input device includes a single/continuous photography mode switch.

20. The information processing apparatus according to claim 12, wherein said input device includes a release switch.

21. The information processing apparatus according to claim 12, wherein said input device includes a user interface displayed on said display.

22. An information processing apparatus comprising:
a sound recording and reproducing system that records and reproduces sound information;
a memo input device that inputs memo information as a line drawing; and
a controller coupled to said sound recording and reproducing system and to said memo input device to operate said apparatus in a memo information input mode for inputting said memo information via said memo input device and either a first sound recording mode that allows selection of said memo information input mode for a predetermined period of time when said sound information is recorded, or a second sound recording mode that allows the recording of subsequent sound information as soon as an ongoing sound information recording process is completed, said controller selecting between said first sound recording mode and said second sound recording mode based on a predetermined signal.

23. A method of controlling an information processing apparatus comprising the steps of:
converting an optical image of an object to image signals;
determining whether an input device of said information processing apparatus has output a predetermined signal; and
based on said predetermined signal, selectively causing said apparatus to operate in a first shooting mode to display said image signals of a photographed object for a predetermined period of time on a display after said photographed object is photographed, or in a second shooting mode to display on said display image signals that are continuously output after shooting said photographed object.

24. The method according to claim 23, further comprising:
selectively operating said apparatus in a memo information input mode to record memo information input as a line drawing, said memo information input mode being operated when said first shooting mode is selected and the predetermined signal is output during said predetermined period of time.

25. The method according to claim 23, wherein said predetermined signal is output by a detector that detects a position of a cover that is movable between an open position for viewing the display and a closed position for protecting said display, wherein when said cover is detected to be in said closed position, said second shooting mode is selected and operation of said display is stopped.

26. The method according to claim 23, wherein said apparatus includes a touch tablet, said method further comprising the step of:
determining whether a pointing device that is used to point to positions on said touch tablet is located in a holder, and wherein said second shooting mode is selected when said pointing device is determined to be located in said holder.

27. The method according to claim 23, wherein said apparatus is operable in a single shooting mode for shooting a single photographic image and a continuous shooting mode for consecutively shooting a plurality of said photographic images, and wherein said predetermined signal indicates whether the single shooting mode or the continuous shooting mode is selected, said first shooting mode being selected when said apparatus is operating in said single shooting mode, and said second shooting mode being selected when said apparatus is operating in said continuous shooting mode.

28. The method according to claim 23, wherein when predetermined input is made from an input device when said image signal is displayed on said display in said first shooting mode, said first shooting mode is switched to said second shooting mode.

29. A method of controlling an information processing apparatus comprising the steps of:
recording and reproducing sound information;
determining whether an input device has output a predetermined signal; and
based on said predetermined signal, selectively operating said apparatus in either a first sound recording mode or in a second sound recording mode, allowing selection of a memo information input mode for a predetermined period of time when said sound information is recorded in said first sound recording mode, said memo information input mode allowing for the input of memo information as a line drawing, and allowing the recording of subsequent sound information as soon as an ongoing sound information recording process is completed in said second sound recording mode.
